(19) United States
(12) Patent Application Publication
(10) Pub. No.: US 2026/0291564 A1
(43) Pub. Date: Sep. 24, 2026

(54) 8TX USER EQUIPMENT PRECODER CODEBOOK FALLBACK

(71) Applicant: QUALCOMM Incorporated, San Diego, CA (US)

(72) Inventors: Yi HUANG, San Diego, CA (US); Kexin XIAO, Shanghai (CN)

(21) Appl. No.: 19/475,692

(22) PCT Filed: Mar. 28, 2024
(86) PCT No.: PCT/CN2024/084298

§ 371 Date: Oct. 15, 2025

(30) Foreign Application Priority Data
May 12, 2023 (WO) PCT/CN2023/093765

(51) Int. Cl. H04B 7/0456

(52) U.S. Cl. CPC H04B 7/0481

(57) ABSTRACT

Various aspects of the present disclosure generally relate to wireless communication. In some aspects, a user equipment (UE) may transmit capability information including: first capability information that indicates a minimum supported value for a coherence parameter, where each value for the coherence parameter corresponds to a respective precoder codebook (CB) set, and second capability information that indicates one or more other values, greater than the minimum supported value, for the coherence parameter that correspond to one or more supported fallback precoder CB sets. The UE may receive configuration information indicating a combination from one or more supported combinations of one or more precoder CB sets based at least in part on the first capability information and the second capability information. Numerous other aspects are described.

### CROSS-REFERENCE TO RELATED APPLICATION

This Patent Application claims priority to International Patent Application No. PCT/CN2023/093765, filed on May 12, 2023, entitled “8TX USER EQUIPMENT PRECODER CODEBOOK FALLBACK,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for 8Tx user equipment precoder codebook fallback.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured to transmit, to a network node, capability information including first capability information that indicates a minimum supported value, of a plurality of values, for a coherence parameter associated with a coherence level for a quantity of transmit (Tx) antennas of the UE, where each value, of the plurality of values, corresponds to a respective precoder codebook (CB) set, and second capability information that indicates one or more other values of the plurality of values, greater than the minimum supported value, for the coherence parameter that correspond to one or more supported fallback precoder CB sets for the quantity of Tx antennas. The one or more processors may be configured to receive, from the network node, configuration information indicating a combination of one or more precoder CB sets, wherein the combination of one or more precoder CB sets is from one or more supported combinations of one or more precoder CB sets based at least in part on the first capability information and the second capability information.

Some aspects described herein relate to a network node for wireless communication. The network node may include one or more memories and one or more processors coupled to the one or more memories. The one or more processors may be configured to receive, from a UE, capability information including first capability information that indicates a minimum supported value, of a plurality of values, for a coherence parameter associated with a coherence level for a quantity of Tx antennas of the UE, where each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas. The one or more processors may be configured to transmit, to the UE, configuration information indicating a combination of one or more precoder CB sets, wherein the combination of one or more precoder CB sets is selected from one or more supported combinations of one or more precoder CB sets based at least in part on the first capability information and the second capability information.

Some aspects described herein relate to a method of wireless communication performed by a UE. The method may include transmitting, to a network node, capability information including first capability information that indicates a minimum supported value, of a plurality of values, for a coherence parameter associated with a coherence level for a quantity of Tx antennas of the UE, where each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas. The method may include receiving, from the network node, configuration information indicating a combination of one or more precoder CB sets, wherein the combination of one or more precoder CB sets is from one or more supported combinations of one or more precoder CB sets based at least in part on the first capability information and the second capability information.

Some aspects described herein relate to a method of wireless communication performed by a network node. The method may include receiving, from a UE, capability information including, first capability information that indicates a minimum supported value, of a plurality of values, for a coherence parameter associated with a coherence level for a quantity of Tx antennas of the UE, where each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas. The method may include transmitting, to the UE, configuration information indicating a combination of one or more precoder CB sets, wherein the combination of one or more precoder CB sets is selected from one or more supported combinations of one or more precoder CB sets based at least in part on the first capability information and the second capability information.

Some aspects described herein relate to a non-transitory computer-readable medium that stores a set of instructions for wireless communication by a UE. The set of instructions, when executed by one or more processors of the UE, may cause the UE to transmit, to a network node, capability information including first capability information that indicates a minimum supported value, of a plurality of values, for a coherence parameter associated with a coherence level for a quantity of Tx antennas of the UE, where each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas. The set of instructions, when executed by one or more processors of the UE, may cause the UE to receive, from the network node, configuration information indicating a combination of one or more precoder CB sets, wherein the combination of one or more precoder CB sets is from one or more supported combinations of one or more precoder CB sets based at least in part on the first capability information and the second capability information.

Some aspects described herein relate to a non-transitory computer-readable medium that stores a set of instructions for wireless communication by a network node. The set of instructions, when executed by one or more processors of the network node, may cause the network node to receive, from a UE, capability information including first capability information that indicates a minimum supported value, of a plurality of values, for a coherence parameter associated with a coherence level for a quantity of Tx antennas of the UE, where each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas. The set of instructions, when executed by one or more processors of the network node, may cause the network node to transmit, to the UE, configuration information indicating a combination of one or more precoder CB sets, wherein the combination of one or more precoder CB sets is selected from one or more supported combinations of one or more precoder CB sets based at least in part on the first capability information and the second capability information.

Some aspects described herein relate to an apparatus for wireless communication. The apparatus may include means for transmitting, to a network node, capability information including first capability information that indicates a minimum supported value, of a plurality of values, for a coherence parameter associated with a coherence level for a quantity of Tx antennas of the apparatus, where each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas. The apparatus may include means for receiving, from the network node, configuration information indicating a combination of one or more precoder CB sets, wherein the combination of one or more precoder CB sets is from one or more supported combinations of one or more precoder CB sets based at least in part on the first capability information and the second capability information.

Some aspects described herein relate to an apparatus for wireless communication. The apparatus may include means for receiving, from a UE, capability information including first capability information that indicates a minimum supported value, of a plurality of values, for a coherence parameter associated with a coherence level for a quantity of Tx antennas of the UE, where each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas. The apparatus may include means for transmitting, to the UE, configuration information indicating a combination of one or more precoder CB sets, wherein the combination of one or more precoder CB sets is selected from one or more supported combinations of one or more precoder CB sets based at least in part on the first capability information and the second capability information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of coherence levels for 8Tx operation for a UE, in accordance with the present disclosure.

FIG. 5 is a diagram illustrating an example associated with 8Tx UE precoder CB fallback, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIGS. 10-11 are diagrams of example apparatuses for wireless communication, in accordance with the present disclosure.

### DETAILED DESCRIPTION

Various aspects relate generally codebook (CB) based uplink transmission for 8Tx operation by a user equipment (UE). “8Tx” refers to transmission using 8 Tx antennas (e.g., transmission via 8 Tx antenna ports). Some aspects more specifically relate to precoder CB fallback for 8Tx operation by a UE. In some examples, a UE may transmit, to a network node, first capability information and second capability information. The first capability information may indicate a minimum supported value, of a plurality of values, for a coherence parameter associated with a coherence level for a quantity (e.g., 8) of Tx antennas of the UE, and each value for the coherence parameter may correspond to a respective precoder CB set. The second capability information may indicate one or more supported combinations of one or more precoder CB sets for the quantity (e.g., 8) of the Tx antennas. Each of the one or more supported combinations may include one or more precoder CB sets including at least one of a precoder CB set corresponding to the minimum supported value for the coherence parameter or one or more fallback precoder CB sets corresponding to one or more other values, greater than the minimum supported value, for the coherence parameter. In some aspects, the second capability information may indicate the one or more supported combinations of one or more CB sets by indicating the one or more other values, greater than the minimum supported value, for the coherence parameter that correspond to one or more supported fallback precoder CB sets for the quantity (e.g., 8) of Tx antennas. The UE may receive, from the network node, configuration information indicating a combination of one or more precoder CB sets of the one or more supported combinations of one or more precoder CB sets.

Particular aspects of the subject matter described in this disclosure can be implemented to realize one or more of the following potential advantages. In some examples, by transmitting, from the UE to the network node, the first capability information that indicates the minimum supported value for the coherence level (e.g., indicating a strongest coherence level supported by the UE) and the second capability information that indicates the one or more supported combinations of one or more precoder CB sets, the described techniques can be used to reduce signaling overhead associated with configuring the UE with a combination of precoder CB sets and/or indicating a precoder CB associated with a precoding matrix to be used for an uplink communication. For example, the signaling overhead may be reduced, as compared with supporting a full precoder CB fallback chain for 8Tx operation of the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

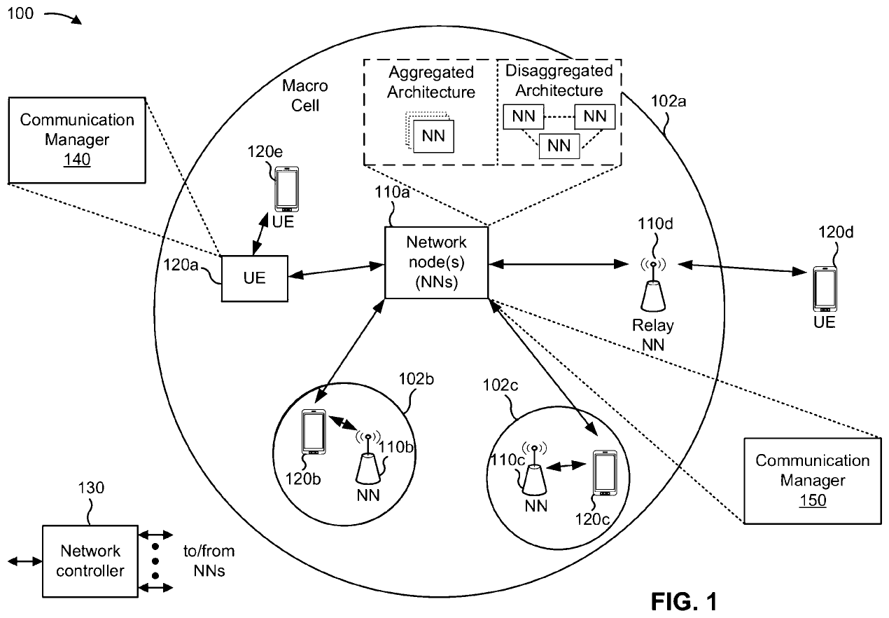

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, to a network node, capability information including: first capability information that indicates a minimum supported value, of a plurality of values, for a coherence parameter associated with a coherence level for a quantity of transmit (Tx) antennas of the UE 120, wherein each value, of the plurality of values, corresponds to a respective precoder CB set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter; and receive, from the network node, configuration information indicating a configured combination of one or more precoder CB sets, wherein the configured combination of one or more precoder CB sets is selected from the one or more supported combinations of one or more precoder CB sets.

Additionally, or alternatively, the communication manager 140 may transmit, to a network node, capability information including: first capability information that indicates a minimum supported value, of a plurality of values, for a coherence parameter associated with a coherence level for a quantity of Tx antennas of the UE 120, wherein each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas; and receive, from the network node, configuration information indicating a combination of one or more precoder CB sets, wherein the combination of one or more precoder CB sets is from one or more supported combinations of one or more precoder CB sets based at least in part on the first capability information and the second capability information. Additionally, or alternatively, the communication manager 140 may perform one or more other operations described herein.

In some aspects, the network node 110 may include a communication manager 150. As described in more detail elsewhere herein, the communication manager 150 may receive, from a UE, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter; and transmit, to the UE, configuration information indicating a configured combination of one or more precoder CB sets, wherein the configured combination of one or more precoder CB sets is selected from the one or more supported combinations of one or more precoder CB sets.

Additionally, or alternatively, the communication manager 150 may receive, from a UE, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas; and transmit, to the UE, configuration information indicating a combination of one or more precoder CB sets, wherein the combination of one or more precoder CB sets is selected from one or more supported combinations of one or more precoder CB sets based at least in part on the first capability information and the second capability information. Additionally, or alternatively, the communication manager 150 may perform one or more other operations described herein.

As indicated above, FIG. 1 is provided as an example. Other examples may differ from what is described with regard to FIG. 1.

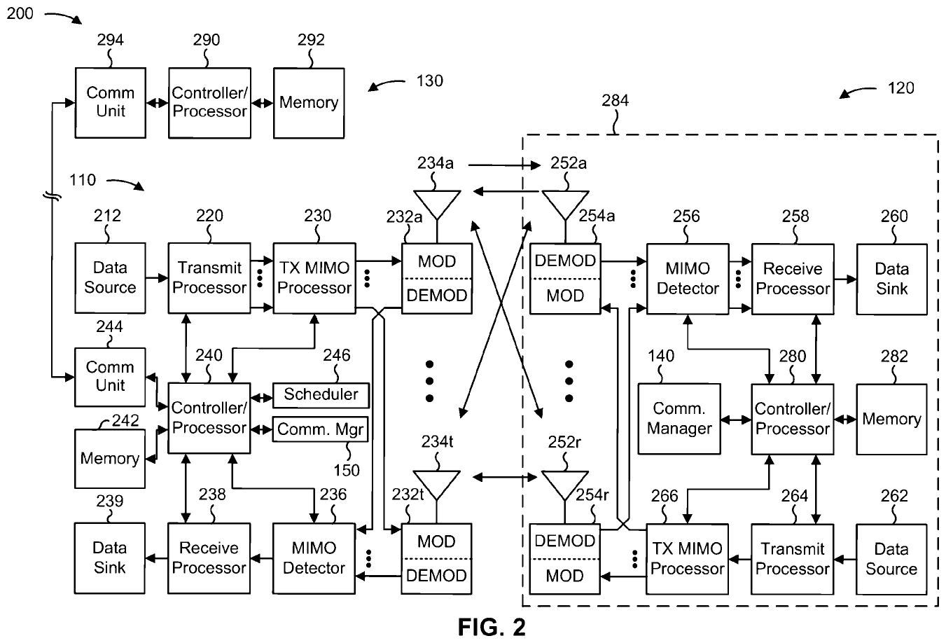

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

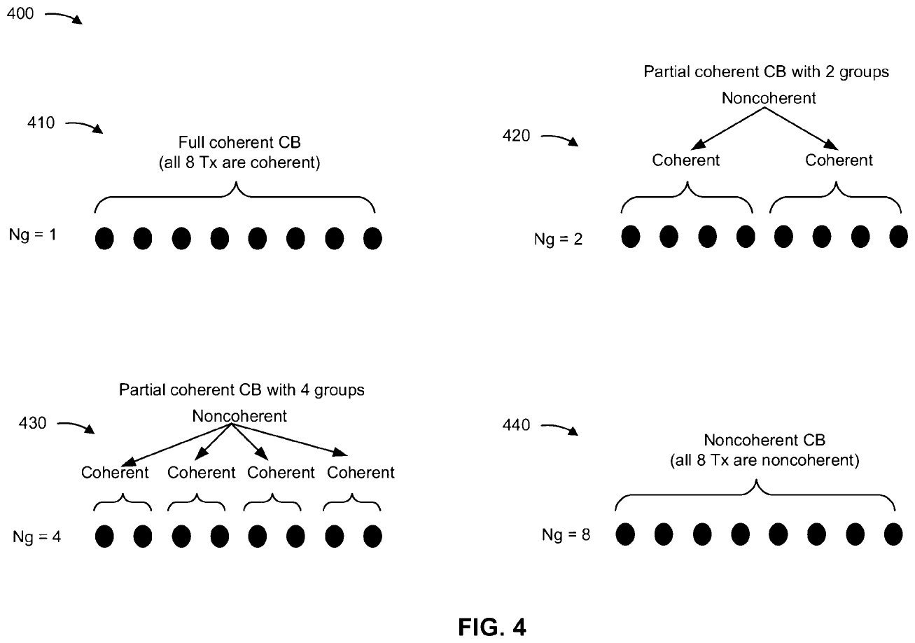

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

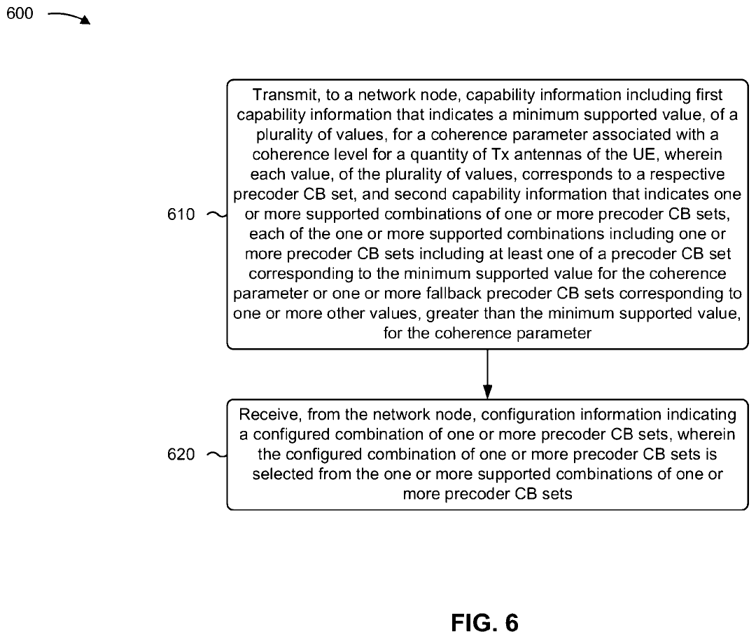

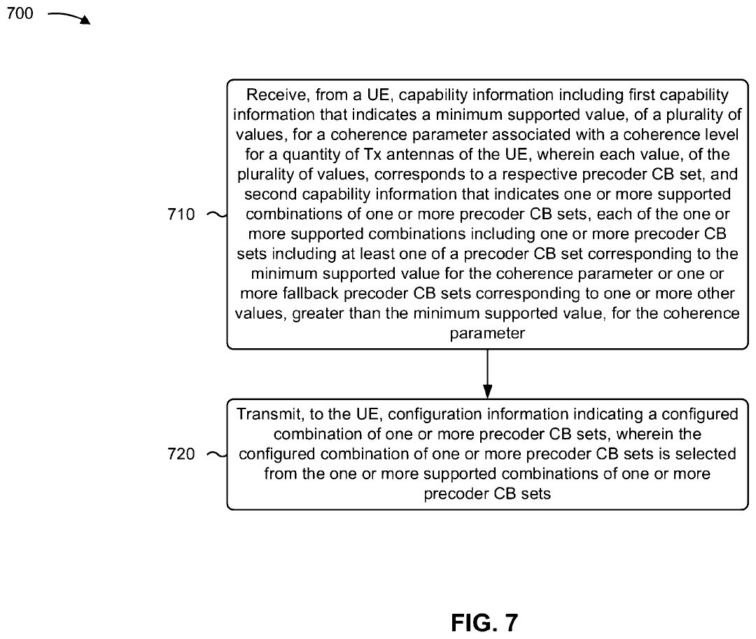

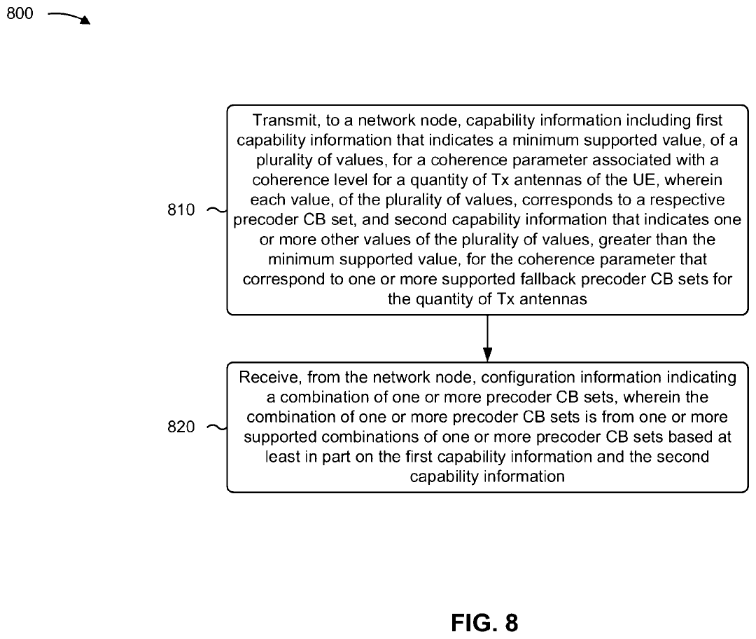

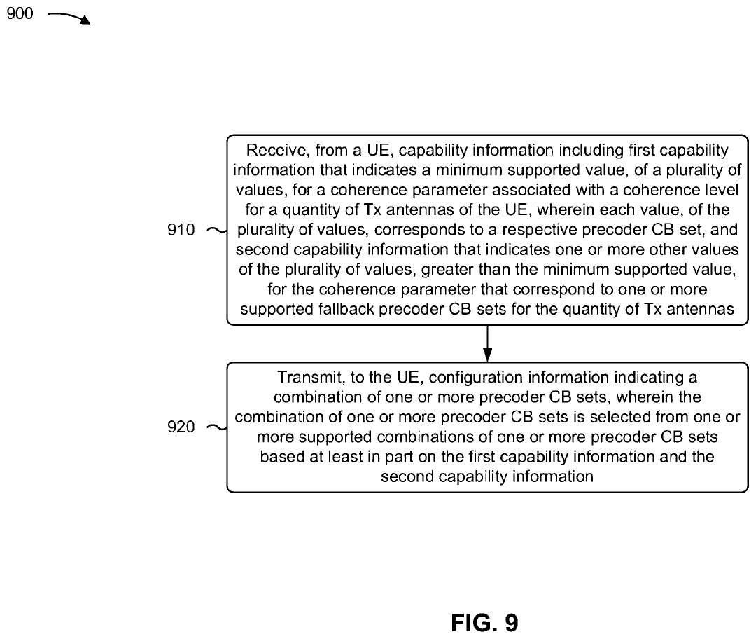

The controller/processor 240 of the network node 110, the controller/processor 280 of the UE 120, and/or any other component(s) of FIG. 2 may perform one or more techniques associated with 8Tx UE precoder CB fallback, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., the UE 120) includes means for transmitting, to a network node, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter; and/or means for receiving, from the network node, configuration information indicating a configured combination of one or more precoder CB sets, wherein the configured combination of one or more precoder CB sets is selected from the one or more supported combinations of one or more precoder CB sets.

In some aspects, a UE (e.g., the UE 120) includes means for transmitting, to a network node, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas; and/or means for receiving, from the network node, configuration information indicating a combination of one or more precoder CB sets, wherein the combination of one or more precoder CB sets is from one or more supported combinations of one or more precoder CB sets based at least in part on the first capability information and the second capability information. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, from a UE, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter; and/or means for transmitting, to the UE, configuration information indicating a configured combination of one or more precoder CB sets, wherein the configured combination of one or more precoder CB sets is selected from the one or more supported combinations of one or more precoder CB sets.

In some aspects, a network node (e.g., the network node 110) includes means for receiving, from a UE, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas; and/or means for transmitting, to the UE, configuration information indicating a combination of one or more precoder CB sets, wherein the combination of one or more precoder CB sets is selected from one or more supported combinations of one or more precoder CB sets based at least in part on the first capability information and the second capability information. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

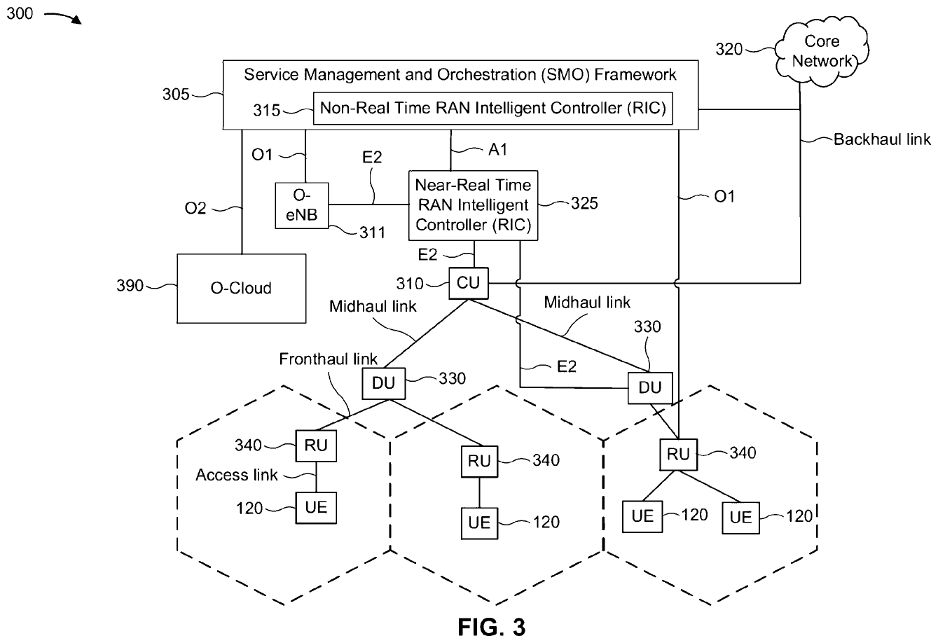

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

In some examples, for CB based uplink transmission, a physical uplink shared channel (PUSCH) communication to be transmitted by a UE may be scheduled via an uplink grant. For example, the uplink grant may be transmitted from a network node to the UE via downlink control information (DCI) (e.g., DCI format 0_0, DCI format 0_1, or DCI format 0_2). The UE may determine a transmission precoder (e.g., precoding matrix) for transmitting the PUSCH communication based on a sounding reference signal (SRS) resource indicator (SRI), a transmit precoding matrix indicator (TPMI), and a transmission rank indicated in the uplink grant (e.g., in DCI fields). In some examples, CB based uplink transmission may be supported (e.g., in the 3GPP NR standard) for 4Tx operation by a UE (e.g., uplink transmission using 4 Tx antennas). In such examples, the UE may determine codebook subsets based on the TPMI and reception of a higher layer parameter (e.g., codebookSubset in pusch-Config for PUSCH associated with DCI format 0_1 or codebookSubset-ForDCIFormat0_2 in pusch-Config for PUSCH associated with DCI format 0_2) which may be configured with ‘fullyAndPartialAndNonCoherent’, ‘partialAndNonCoherent’, or ‘nonCoherent’, depending on the UE capability. The UE may report a UE capability of ‘fullyAndPartialAndNonCoherent’ (e.g., in a case in which the UE is capable of supporting full coherence between the 4 Tx antennas), a UE capability of ‘partialAndNonCoherent’ (e.g., in a case in which the UE is capable of supporting partial coherence for the 4 Tx antennas), or a UE capability of ‘nonCoherent’ (e.g., in a case in which the UE does not support coherence between the 4 Tx antennas). A UE reporting the UE capability of ‘nonCoherent’ does not expect to be configured by the higher layer parameter (e.g., codebookSubset or codebookSubset-ForDCIFormat0_2) with ‘fullyAndPartialAndNonCoherent’ or with ‘partialAndNonCoherent’. A UE reporting the UE capability of ‘partialAndNonCoherent’ does not expect to be configured by the higher layer parameter (e.g., codebookSubset or codebookSubset-ForDCIFormat0_2) with ‘fullyAndPartialAndNonCoherent’, but may be configured by the higher layer parameter with the ‘partialAndNonCoherent’ codebook subset or the ‘nonCoherent’ codebook subset. A UE reporting the UE capability of ‘fullyAndPartialAndNonCoherent’ may be configured by the higher layer parameter (e.g., codebookSubset or codebookSubset-ForDCIFormat0_2) with ‘fullyAndPartialAndNonCoherent’, ‘partialAndNonCoherent’, or ‘nonCoherent’.

FIG. 4 is a diagram illustrating an example 400 of coherence levels for 8Tx operation for a UE, in accordance with the present disclosure.

In some aspects, 8Tx operation by a UE may be supported for uplink communications. “8Tx” refers to transmission using 8 Tx antennas (e.g., transmission via 8 Tx antenna ports). For example, a UE may be equipped with 8 Tx antennas and 8 Tx antenna ports respectively associated with the 8 Tx antennas, and the UE may transmit uplink communications via beams formed using one or more of the 8 Tx antennas. In some aspects, CB based uplink transmission may be supported for 8Tx operation by a UE. As shown in FIG. 4, UEs may support different coherence levels for 8Tx operation for uplink communications. A “coherence level” may refer to a capability of a UE to maintain coherence between signals transmitted via all or a subset of the 8 Tx antennas (or 8 Tx antenna ports) (e.g., to transmit layer of uplink data coherently). In some examples, multiple types of precoder CBs may be supported in a wireless communication standard (e.g., a 3GPP standard) with different types of precoder CBs corresponding to different coherence levels.

As shown in FIG. 4, and by reference number 410, a first coherence level corresponds to full coherence between the 8 Tx antennas (e.g., the 8 Tx antenna ports) of the UE. For example, a UE with a capability of supporting the first coherence level (e.g., full coherence) may be capable of maintaining coherence between signals transmitted via all 8 Tx antennas of the UE. A first type of precoder CB (e.g., a full coherent CB type) may be associated with the first coherence level. For example, the first type of precoder CB may be used to indicate precoder CBs for uplink transmissions associated with the first coherence level (e.g., full coherence).

As shown in FIG. 4, and by reference number 420, a second coherence level corresponds to partial coherence with two antenna groups for the 8 Tx antennas of the UE. At the second coherence level, coherence may be maintained between the four antennas in each antenna group, but the two antenna groups may be non-coherent with respect to each other (e.g., coherence may not be maintained between the antenna groups). For example, a UE with a capability of supporting the second coherence level (e.g., partial coherence with two antenna groups) may be capable of maintaining coherence between signals transmitted within each of two groups of 4 Tx antennas of the 8 Tx antennas of the UE. A second type of precoder CB (e.g., a partial coherent CB with 2 groups) may be associated with the second coherence level. For example, the second type of precoder CB may be used to indicate precoder CBs for uplink transmissions associated with the second coherence level (e.g., partial coherence with 2 groups).

As shown in FIG. 4, and by reference number 430, a third coherence level corresponds to partial coherence with four antenna groups for the 8 Tx antennas of the UE. At the third coherence level, coherence may be maintained between the two antennas in each antenna group, but the four antenna groups may be non-coherent with respect to each other (e.g., coherence may not be maintained between the antenna groups). For example, a UE with a capability of supporting the third coherence level (e.g., partial coherence with four antenna groups) may be capable of maintaining coherence between signals transmitted within each of four groups of 2 Tx antennas of the 8 Tx antennas of the UE. A third type of precoder CB (e.g., a partial coherent CB with 4 groups) may be associated with the third coherence level. For example, the third type of precoder CB may be used to indicate precoder CBs for uplink transmissions associated with the third coherence level (e.g., partial coherence with 4 groups).

As shown in FIG. 4, and by reference number 440, a fourth coherence level corresponds to non-coherence for the 8 Tx antennas of the UE. At the fourth coherence level, all 8 of the Tx antennas may be non-coherent with respect to each other. For example, a UE may not maintain coherence between signals transmitted by any different Tx antennas of the 8 Tx antennas of the UE. A fourth type of precoder CB (e.g., noncoherent CB) may be associated with the fourth coherence level. For example, the fourth type of precoder CB may be used to indicate precoder CBs for uplink transmissions associated with the fourth coherence level (e.g., non-coherence).

In some aspects, a coherence parameter (Ng) may be associated with the coherence level for a quantity of Tx antennas (e.g., 8 Tx antennas). For example, a first value of the coherence parameter (e.g., Ng=1) may correspond to the first coherence level (e.g., full coherence), a second value of the coherence parameter (e.g., Ng=2) may correspond to the second coherence level (e.g., partial coherence with 2 groups), a third value of the coherence parameter (e.g., Ng=4) may correspond to the third coherence level (e.g., partial coherence with 4 groups), and a fourth value of the coherence parameter (e.g., Ng=8) may correspond to the fourth coherence level (e.g., non-coherence). In some examples, the value of the coherence parameter may indicate a quantity of groups of the Tx antennas of the UE within which coherence is maintained at the corresponding coherence level. In this case, Ng=1 indicates a single group for all Tx antennas with full coherence therebetween (e.g., coherence is maintained within a single group including all of the Tx antennas), and Ng=8 indicates eight groups for the 8 Tx antennas with non-coherence therebetween (e.g., coherence is maintained within 8 antenna groups, each group including a single Tx antenna). In some other examples, the coherence parameter (Ng) may use other values to indicate the different coherence levels.

In some aspects, each value of the coherence parameter (e.g., each Ng value) may correspond to a respective set of precoder CBs. Each set of precoder CBs may include one or more precoder CBs, each associated with a respective precoder matrix. For each Ng value, the respective set of precoder CBs corresponding to the Ng value may include precoder CBs of the precoder CB type associated with the coherence level indicated by that Ng value. For example, a precoder CB set corresponding to Ng=1 (e.g., full coherence) may include precoder CBs of the first precoder CB type, a precoder CB set corresponding to Ng=2 (e.g., partial coherence with 2 groups) may include precoder CBs of the second precoder CB type, a precoder CB set corresponding to Ng=4 (e.g., partial coherence with 4 groups) may include precoder CBs of the third precoder CB type, and a precoder CB set corresponding to Ng=8 (e.g., non-coherence) may include precoder CBs of the fourth precoder CB type.

Support for the different types of precoder CBs associated with the different coherence levels may be associated with different levels of UE implementation complexity for a quantity of Tx antennas of the UE. For example, support for the first type of precoder CB associated with 8 Tx full coherence (e.g., Ng=1) may be more complicated for a UE to implement than support for the second type of precoder CB associated with partial coherence with 2 antenna groups (e.g., Ng=2) for the same quantity of Tx antennas. Support for the second type of precoder CB associated with partial coherence with 2 antenna groups (e.g., Ng=2) may be more complicated for a UE to implement than support for the third type of precoder CB associated with partial coherence with 4 antenna groups (e.g., Ng=4) for the same quantity of Tx antennas. Support for the third type of precoder CB associated with partial coherence with 4antenna groups (e.g., Ng=4) may be more complicated for a UE to implement than support for the fourth type of precoder CB associated with non-coherence (e.g., Ng=8) for the same quantity of Tx antennas.

In some examples, a full fallback chain may be supported for 8Tx operation for a UE. A fallback chain, for precoder CB fallback, may refer to one or more precoder CB types (e.g., one or more sets of precoder CBs) associated with coherence levels with less complexity than a strongest (e.g., most complex, most stringent, or most rigorous) coherence level (e.g., smallest Ng value) supported by a UE, that the UE can fall back to support. A full fallback chain may include all possible combinations of one or more precoder CB sets among the precoder CB sets corresponding to the strongest (e.g., most stringent or most rigorous) coherence level (e.g., minimum Ng value) supported by the UE and precoder CB sets corresponding to any less complicated coherence levels (e.g., one or more Ng values greater than the minimum Ng value supported by the UE) for the quantity of Tx antennas. For example, a UE with 8 Tx antennas supporting Ng=1 can fallback to support Ng=2, Ng=4, and Ng=8. In this case, a network node may configure the UE with any of the following combinations of precoder CB sets: {Ng=1, 2, 4, 8}, {Ng=1, 2, 4}, {Ng=1, 2, 8}, {Ng=1, 4, 8}, {Ng==2,4,8}, {Ng=1,2}, {Ng=1,4}, {Ng=1,8}, {Ng=2,4}, {Ng=2,8}, {Ng=4, 8}, {Ng=1}, {Ng=2}, {Ng=4}, and/or {Ng=8}. As used herein, {Ng=one or more Ng values} denotes a combination of precoder CB sets that includes one or more precoder CB sets corresponding to the one or more Ng values. A UE with 8 Tx antennas supporting Ng=2 can fallback to support Ng=4 and Ng=8. In this case, a network node may configure the UE with any of the following combinations of precoder CB sets: {Ng=2, 4, 8}, {Ng=2,4}, {Ng=2,8}, {Ng=4,8}, {Ng=2}, {Ng=4}, and/or {Ng=8}. A UE with 8 Tx antennas supporting Ng=4 can fallback to support Ng=8. In this case, a network node may configure the UE with any of the following combinations of precoder CB sets: {Ng=4, 8}, {Ng=4}, and/or {Ng=8}. A UE with 8 Tx antennas supporting Ng=8 can only support the precoding CB set {Ng=8}. The above full precoder CB fallback chain for 8Tx operation may be complicated to implement. For example, the full precoder CB fallback chain for 8Tx operation may be complicated, as compared with 4Tx operation, due to an increase in the quantity of coherence levels associated with 8Tx operation. As a result, supporting the full precoder CB fallback chain for 8Tx operation may result in an increased signaling overhead for configuring a UE with a combination of precoder CB sets and/or indicating a precoder CB associated with a precoding matrix. That said, full precoder CB fallback chain implementations will become even more complicated for UEs with potential 16 Tx operations, or even 32 Tx operations.

Some techniques and apparatuses described herein enable UE capability reporting on a capability associated with a coherence level and UE capability reporting on supported fallback precoding CB sets for a same quantity of Tx antennas (e.g., for 8Tx operation). In some aspects, a UE may transmit, to a network node, first capability information and second capability information. The first capability information may indicate a minimum supported value, of a plurality of values, for a coherence parameter associated with a coherence level for a quantity (e.g., 8) of Tx antennas of the UE, and each value for the coherence parameter may correspond to a respective precoder CB set. The second capability information may indicate one or more supported combinations of one or more precoder CB sets for the same quantity of Tx antennas. Each of the one or more supported combinations may include one or more precoder CB sets including at least one of a precoder CB set corresponding to the minimum supported value for the coherence parameter or one or more fallback precoder CB sets corresponding to one or more other values, greater than the minimum supported value, for the coherence parameter. In some aspects, the second capability information may indicate the one or more supported combinations of one or more CB sets by indicating the one or more other values, greater than the minimum supported value, for the coherence parameter that correspond to one or more supported fallback precoder CB sets for the quantity of Tx antennas. The UE may receive, from the network node, configuration information indicating a combination of one or more precoder CB sets of the one or more supported combinations of one or more precoder CB sets. As a result, signaling overhead associated with configuring the UE with a combination of precoder CB sets and/or indicating a precoder CB associated with a precoding matrix to be used for an uplink communication may be reduced.

As indicated above, FIG. 4 is provided as an example. Other examples may differ from what is described with respect to FIG. 4.

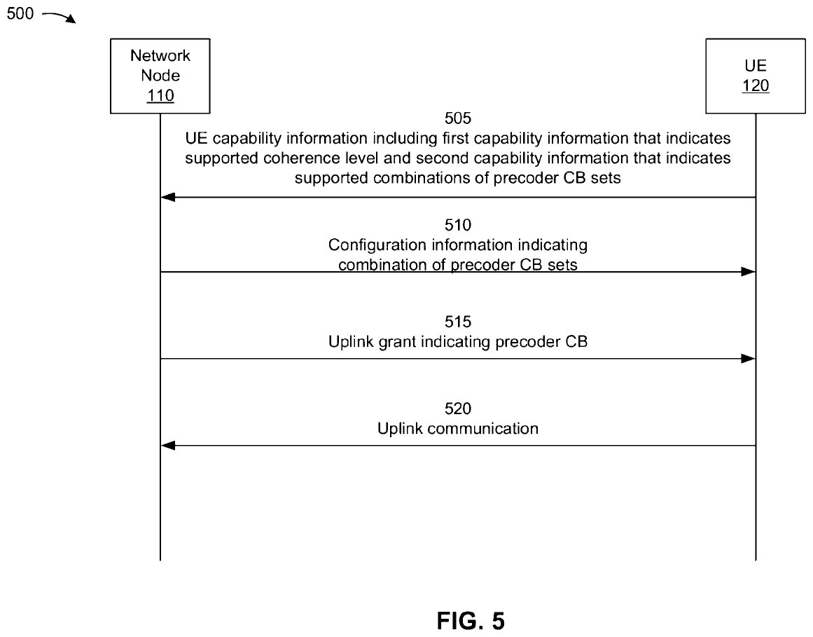

FIG. 5 is a diagram illustrating an example 500 associated with 8Tx UE precoder CB fallback, in accordance with the present disclosure. As shown in FIG. 5, example 500 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink. The UE 120 and the network node 110 may have established a wireless connection prior to operations shown in FIG. 5.

As shown in FIG. 5, and by reference number 505, the UE 120 may transmit, and the network node may receive, UE capability information including first capability information and second capability information. For example, the UE 120 may transmit the UE capability information (e.g., in a UE capability report) via an RRC message or a MAC control element (MAC-CE). The first capability information may indicate a supported coherence level (e.g., a strongest coherence level supported by the UE 120), and the second capability information may indicate one or more supported combinations of precoder sets.

In some aspects, the first capability information may indicate a minimum supported value, of a plurality of values, for a coherence parameter (Ng) associated with a coherence level for a quantity (e.g., 8) of Tx antennas of the UE 120. In some aspects, the minimum supported value (e.g., the minimum Ng value) may indicate the strongest coherence level supported by the UE 120. For 8Tx operation, the plurality of values for the coherence parameter (Ng) may include a first value associated with full coherence for 8 Tx antennas of the UE 120, a second value associated with partial coherence with two antenna groups for the 8 Tx antennas, a third value associated with partial coherence with four antenna groups for the 8 Tx antennas, and a fourth value associated with non-coherence for the 8 Tx antennas. In some examples, the value of the coherence parameter may indicate a quantity of groups of the Tx antennas within which coherence is maintained at the corresponding coherence level. For example, as described above in connection with FIG. 4, Ng=1 may be associated with full coherence for the 8 Tx antennas, Ng=2 may be associated with partial coherence with two antenna groups, Ng=4 may be associated with partial coherence with four antenna groups, and Ng=8 may be associated with non-coherence for the 8 Tx antennas. Hereinafter, the Ng values of Ng=1, 2, 4, and 8 are used to indicate full coherence, partial coherence with two antenna groups, partial coherence with four antenna groups, and non-coherence, respectively, for 8Tx operation in the examples described herein. In some other examples, other values for Ng may be used to indicate the different coherence levels.

In some aspects, each value for the coherence parameter (e.g., each Ng value) may correspond to a respective precoder CB set that includes one or more precoder CBs. Each precoder CB, of the one or more precoder CBs in a precoder CB set, may be associated with a respective precoding matrix. For example, each precoder CB, in a precoder CB set, may map to the respective precoding matrix, such that an indication of the precoder CB (e.g., included in an uplink grant transmitted to the UE 120 from the network node 110) indicates that the respective precoding matrix associated with the precoder CB is to be used by the UE 120 for transmitting an uplink communication. For each Ng value, the precoder CBs included in the respective precoder CB set may be precoder CBs of a precoder CB type associated with the Ng value. The precoder CB type may correspond to the coherence level indicated by the Ng value. For example, a precoder CB set associated with Ng=1 may include one or more precoder CBs of a precoder CB type associated with full coherence for 8 Tx antennas, a precoder CB set associated with Ng=2 may include one or more precoder CBs of a precoder CB type associated with partial coherence with two antenna groups for 8 Tx antennas, a precoder CB set associated with Ng=4 may include one or more precoder CBs of a precoder CB type associated with partial coherence with four antenna groups, and a precoder CB set associated with Ng=8 may include one or more precoder CBs of a precoder CB type associated with non-coherence for 8 Tx antennas.

In some aspects, the second capability information may include capability information relating to one or more fallback CB precoder sets supported by the UE 120 in connection with the minimum supported Ng value (e.g., indicating the strongest/most stringent/most rigorous supported coherence level) indicated in the first capability information. “Fallback precoder CB set” may refer to a precoder CB set that corresponds to an Ng value greater than the minimum supported Ng value for the quantity of Tx antennas (e.g., a value for the coherence parameter greater than the minimum supported value for the coherence parameter). In some aspects, the second capability information may indicate one or more supported combinations of one or more precoder CB sets. As used herein, “a combination of precoder CB sets” (or a combination of one or more precoder CB sets) may refer to one or more precoder CB sets (e.g., corresponding to one or more respective Ng values for the same quantity of Tx antennas). For example, in some cases, a combination of precoder CB sets may include a single precoder CB set (e.g., associated with a single Ng value), and in some cases, a combination of precoder CB sets may include a combination of multiple CB sets (e.g., corresponding to multiple Ng values). Each supported combination, of the one or more supported combinations indicated by the second capability information, may include one or more precoder CB sets, including at least one of a precoder CB set corresponding to the minimum supported value for the coherence parameter (e.g., the minimum Ng value) or one or more fallback precoder CB sets corresponding to one or more other values, greater than the minimum supported value, for the coherence parameter.

In some examples, a supported combination, of the one or more supported combinations, may include the precoder CB set corresponding to the minimum supported Ng value and one or more fallback precoder CB sets corresponding to one or more other Ng values that are greater than the minimum supported Ng value. Additionally, or alternatively, a supported combination, of the one or more supported combinations, may include one or more fallback precoder CB sets corresponding to one or more Ng values that are greater than the minimum supported Ng value, and may not include the precoder CB set corresponding to the minimum supported Ng value. Additionally, or alternatively, a supported combination, of the one or more supported combinations, may include two or more fallback precoder CB sets corresponding to two or more Ng values that are greater than the minimum supported Ng value (e.g., with or without including the precoder CB set corresponding to the minimum supported Ng value).

In some aspects, the second capability information may include a respective indication, for each supported combination of the one or more supported combinations of one or more precoder CB sets, of one or more values for the coherence parameter (e.g., one or more Ng values) that correspond to the one or more precoder CB sets included in that supported combination of one or more precoder CB sets. In this case, the UE 120 may indicate, in the second capability information, each supported combination of one or more precoder CB sets as a combination of one or Ng values (e.g., a subset of the Ng values) that correspond to the one or more precoder CB sets included in the supported combination. In one example, in a case in which the UE 120 supports Ng=1 (e.g., the first capability information indicates the minimum supported Ng value of Ng=1), the UE 120 may indicate, in the second capability information, the following supported combinations of one or more precoder CB sets: {Ng=1, 2, 8}, {Ng =2,8}, and {Ng=8}. In another example, in a case in which the UE 120 supports Ng=2 (e.g., the first capability information indicates the minimum supported Ng value of Ng=2), the UE 120 may indicate, in the second capability information, the following supported combinations of one or more precoder CB sets: {Ng=2, 4, 8}, {Ng=2}, {Ng=4}, and {Ng=8}. In another example, in a case in which the UE 120 supports Ng=4 (e.g., the first capability information indicates the minimum supported Ng value of Ng=4), the UE 120 may indicate, in the second capability information, the following supported combinations of one or more precoder CB sets: {Ng=4, 8} and {Ng=4}. In some examples, in a case in which the UE 120 supports Ng=8 (e.g., the first capability information indicates the minimum supported Ng value of Ng=8), the UE 120 may only support the precoder CB set {Ng=8}, and the UE 120 may not report the second capability information.

In some aspects, the second capability information may include an indication of one or more values (e.g., Ng values), greater than the minimum supported value for the coherence parameter (e.g., the minimum supported Ng value), that correspond to one or more fallback precoder CB sets supported by the UE 120. For example, the UE 120 may indicate the minimum supported Ng value (e.g., indicating the strongest supported coherence level) in the first capability information, and the UE 120 may indicate, in the second capability information, one or more other Ng values (e.g., one or more Ng values greater than the minimum supported Ng value) corresponding to one or more supported fallback precoder CB sets. In some aspects, in a case in which the second capability information includes the indication of the one or more Ng values corresponding to the one or more fallback precoder CB sets, the UE 120 may be required to support all combinations of one or more of the precoder CB sets corresponding to the minimum supported Ng value and the other Ng values indicated in the second capability information. This may reduce the signaling overhead for the UE 120, as compared with explicitly indicating each of the supported combinations of one or more precoder CB sets. In such examples, the one or more supported combinations (e.g., indicated by the one or more Ng values in the second capability information) include respective supported combinations for all combinations of one or more of the precoder CB sets corresponding to one or more of the minimum supported Ng value or the one or more other Ng values (e.g., indicated in the second capability information), greater than the minimum supported Ng value. For example, one or more supported combinations may include a supported combination including the precoder CB set corresponding to the minimum supported Ng value, a respective supported combination, for each other Ng value indicated in the second capability information, including a fallback precoder CB set corresponding to the other Ng value, and a respective supported combination, for each combination of two or more Ng values among the minimum supported Ng value and the one or more other Ng values indicated in the second capability information, that includes a respective combination of two or more precoder CB sets among the precoder CB set corresponding to the minimum supported Ng value and the fallback precoder CB sets corresponding to the one or more other Ng values.

In one example, in a case in which the UE 120 supports Ng=1 (e.g., the first capability information indicates the minimum supported Ng value of Ng=1), the UE 120 may indicate, in the second capability information, the following supported Ng values for fallback: Ng=4 and Ng=8. In this example, the indication of Ng=4 and Ng =8 in the second capability information may indicate that the UE 120 supports the following combinations of one or more precoder CB sets: {Ng=1, 4, 8}, {Ng=1, 4},{Ng=1, 8}, {Ng=4, 8}, {Ng=1}, {Ng=4}, and {Ng=8}. In another example, in a case in which the UE 120 supports Ng=2 (e.g., the first capability information indicates the minimum supported Ng value of Ng=2), the UE 120 may indicate, in the second capability information, a supported value of Ng=8 for fallback. In this example, the indication of Ng=8 in the second capability information may indicate that the UE 120 supports the following combinations of one or more precoder CB sets: {Ng=2, 8}, {Ng=2}, and {Ng=8}. In another example, in a case in which the UE 120 supports Ng=4 (e.g., the first capability information indicates the minimum supported Ng value of Ng=4), the UE 120 may indicate, in the second capability information, a supported value of Ng=8 for fallback. In this example, the indication of Ng=8 in the second capability information may indicate that the UE 120 supports the following combinations of one or more precoder CB sets: {Ng=4,8}, {Ng=4}, and {Ng=8}. In some examples, in a case in which the UE 120 supports Ng=8 (e.g., the first capability information indicates the minimum supported Ng value of Ng=8), the UE 120 may only support the precoder CB set {Ng=8}, and the UE 120 may not report the second capability information.

In some aspects, in a case in which the second capability information includes the indication of the one or more Ng values (e.g., one or more Ng values greater than the minimum supported Ng value indicated in the first capability information) corresponding to one or more fallback precoder CB sets supported by the UE 120, the one or more Ng values indicated in the second capability information may provide an indication that the UE 120 supports a subset of combinations of a set of possible combinations of one or more precoder CB sets corresponding to the one or more of the minimum supported Ng value or the one or more other Ng values indicated in the second capability information. For example, the subset of combinations of precoder CB sets may be preconfigured for the UE 120 (e.g., specified in a wireless communication standard) for each combination of the minimum supported Ng value and one or more other Ng values supported for fallback. In some examples, in a case in which the second capability information indicates a single Ng value, greater than the minimum supported Ng value, the supported combinations of one or more precoder CB sets may include a supported combination that includes the precoder CB set corresponding to the minimum supported Ng value and a fallback precoder CB set corresponding to the single indicated Ng value, greater than the minimum supported Ng value, and a supported combination that includes the fallback precoder CB set corresponding to the single indicated Ng value, greater than the minimum supported Ng value, and does not include the precoder CB corresponding to the minimum supported Ng value. In some examples, in a case in which the second capability information indicates multiple indicated Ng values, greater than the minimum supported Ng value, the supported combinations of one or more precoder CB sets may include a supported combination that includes the precoder CB set corresponding to the minimum supported Ng value and a respective fallback precoder CB set corresponding to each indicated Ng value of the multiple indicated Ng values, greater than the minimum supported Ng value, a respective supported combination, for each combination of two or more Ng values of the multiple indicated Ng values, greater than the minimum supported Ng value, that includes a respective combination of fallback precoder CB sets corresponding to the combination of the two or more Ng values, and a supported combination that includes a single fallback precoder CB set corresponding to a highest Ng value of the multiple indicated Ng values, greater than the minimum supported Ng value.

In one example, in a case in which the UE 120 supports Ng=1 (e.g., the first capability information indicates the minimum supported Ng value of Ng=1), the UE 120 may indicate, in the second capability information, the following supported Ng values for fallback: Ng=4 and Ng=8. In this example, the indication of Ng=4 and Ng =8 in the second capability information may indicate that the UE 120 supports the following combinations of one or more precoder CB sets (e.g., the following subset of combinations including the precoder CB sets corresponding to Ng=1, Ng=4, and Ng=8): {Ng=1,4,8}, {Ng=4,8}, and {Ng=8}. In another example, in a case in which the UE 120 supports Ng=2 (e.g., the first capability information indicates the minimum supported Ng value of Ng=2), the UE 120 may indicate, in the second capability information, a supported value of Ng=8 for fallback. In this example, the indication of Ng=8 in the second capability information may indicate that the UE 120 supports the following combinations of one or more precoder CB sets: {Ng=2, 8} and {Ng=8}. In another example, in a case in which the UE 120 supports Ng=4 (e.g., the first capability information indicates the minimum supported Ng value of Ng=4), the UE 120 may indicate, in the second capability information, a supported value of Ng=8 for fallback. In this example, the indication of Ng=8 in the second capability information may indicate that the UE 120 supports the following combinations of one or more precoder CB sets: {Ng=4, 8} and {Ng=8}. In some examples, in a case in which the UE 120 supports Ng=8 (e.g., the first capability information indicates the minimum supported Ng value of Ng=8), the UE 120 may only support the precoder CB set {Ng=8}, and the UE 120 may not report the second capability information.

As further shown in FIG. 5, and by reference number 510, the network node may transmit, and the UE may receive, configuration information indicating a combination of one or more precoder CB sets. In some aspects, the UE may receive the configuration information via one or more of RRC signaling, one or more MAC-CEs, and/or DCI, among other examples. The combination of one or more precoder CB sets indicated in the configuration information may be referred to as the “configured combination of one or more precoder CB sets.” The configured combination of one or more precoder CB sets, indicated in the configuration information, may be a supported combination of one or more precoder CB sets of the one or more supported combinations of one or more precoder CB sets indicated by the second capability information. For example, the network node 110 may select the configured combination of one or more precoder CB sets from the one or more supported combinations of one or more precoder CB sets indicated by the second capability information. In some examples, the configuration information may include a higher layer (e.g., RRC) parameter that indicates the configured combination of one or more precoder sets.

In some aspects, as further shown in FIG. 5, and by reference number 515, the network node 110 may transmit, and the UE 120 may receive, an uplink grant indicating a precoder CB. The uplink grant may schedule an uplink communication (e.g., a PUSCH communication) for the UE 120. In some aspects, the uplink grant may be included in DCI, such as DCI format 0_0, DCI format 0_1, or DCI format 0_2. In some aspects, the precoder CB may be indicated in a TPMI field of the DCI. The precoder CB may be a precoder CB included in a precoder CB set of the one or more precoder CB sets included in the configured combination of one or more CB sets indicated in the configuration information. The precoder CB may be associated with a precoding matrix. For example, the precoder CB may map to a precoding matrix to be used by the UE 120 for transmitting the uplink communication scheduled by the uplink grant. The precoder CB may be associated with a precoder CB type corresponding to a coherence level (e.g., for 8Tx operation by the UE 120). For example, the precoding matrix associated with the precoder CB may correspond to precoding associated with transmitting the uplink communication at the corresponding coherence level.

As further shown in FIG. 5, and by reference number 520, the UE 120 may transmit, and the network node 110 may receive, the uplink communication scheduled by the uplink grant. For example, the uplink communication may be a PUSCH communication. The UE 120 may transmit the uplink communication based at least in part on the precoding matrix associated with the precoder CB indicated in the uplink grant. In some aspects, the UE 120 may transmit the uplink communication using all or a subset of 8 Tx antennas of the UE 120 at a coherence level corresponding to the precoding matrix associated with the precoder CB indicated in the uplink grant.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE 120) performs operations associated with 8Tx UE precoder CB fallback.

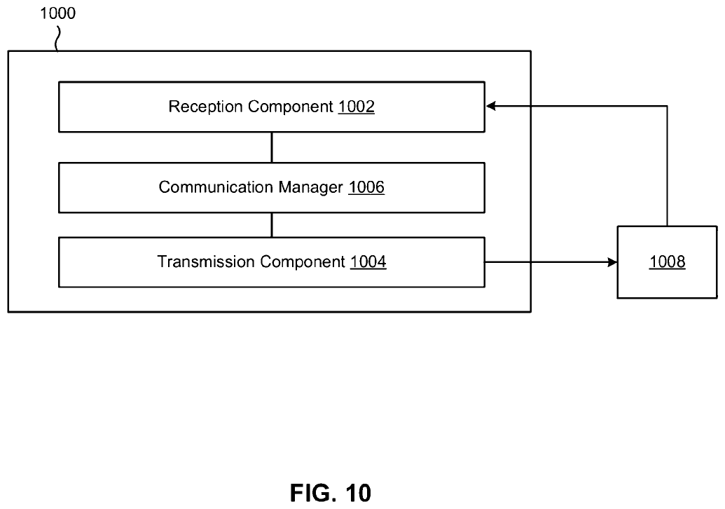

As shown in FIG. 6, in some aspects, process 600 may include transmitting, to a network node, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter (block 610). For example, the UE (e.g., using transmission component 1004 and/or communication manager 1006, depicted in FIG. 10) may transmit, to a network node, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter, as described above.

As further shown in FIG. 6, in some aspects, process 600 may include receiving, from the network node, configuration information indicating a configured combination of one or more precoder CB sets, wherein the configured combination of one or more precoder CB sets is selected from the one or more supported combinations of one or more precoder CB sets (block 620). For example, the UE (e.g., using reception component 1002 and/or communication manager 1006, depicted in FIG. 10) may receive, from the network node, configuration information indicating a configured combination of one or more precoder CB sets, wherein the configured combination of one or more precoder CB sets is selected from the one or more supported combinations of one or more precoder CB sets, as described above.

Process 600 may include additional aspects, such as any single aspect or any combination of aspects described below and/or in connection with one or more other processes described elsewhere herein.

In a first aspect, process 600 includes receiving, from the network node, an uplink grant for an uplink communication, the uplink grant indicating a precoder CB from a precoder CB set of the configured combination of one or more precoder CB sets indicated in the configuration information, and transmitting, to the network node, the uplink communication based at least in part on a precoding matrix associated with the precoder CB indicated in the uplink grant.

In a second aspect, alone or in combination with the first aspect, the quantity of Tx antennas is eight Tx antennas, and the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.

In a third aspect, alone or in combination with one or more of the first and second aspects, the second capability information includes, for each of the one or more supported combinations of one or more precoder CB sets, a respective indication of one or more values for the coherence parameter that correspond to the one or more precoder CB sets included in that supported combination of one or more precoder CB sets.

In a fourth aspect, alone or in combination with one or more of the first through third aspects, the one or more supported combinations of one or more precoder CB sets include a supported combination that includes the precoder CB set corresponding to the minimum supported value for the coherence parameter and the one or more fallback precoder CB sets corresponding to the one or more other values, greater than the minimum supported value, for the coherence parameter.

In a fifth aspect, alone or in combination with one or more of the first through fourth aspects, the one or more supported combinations of one or more precoder CB sets include a supported combination that includes at least one of the one or more fallback precoder CB sets corresponding to the one or more other values, greater than the minimum supported value, for the coherence parameter, and does not include the precoder CB set corresponding to the minimum supported value for the coherence parameter.

In a sixth aspect, alone or in combination with one or more of the first through fifth aspects, the one or more supported combinations of one or more precoder CB sets include a supported combination that includes at least two fallback precoder CB sets corresponding to at least two other values, greater than the minimum supported value, for the coherence parameter.

In a seventh aspect, alone or in combination with one or more of the first through sixth aspects, the second capability information includes an indication of the one or more other values, greater than the minimum supported value, for the coherence parameter, and the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.

In an eighth aspect, alone or in combination with one or more of the first through seventh aspects, the second capability information includes an indication of the one or more other values, greater than the minimum supported value, for the coherence parameter, and the one or more supported combinations of one or more precoder CB sets include a supported combination including the precoder CB set corresponding to the minimum supported value for the coherence parameter, a respective supported combination, for each other value of the one or more other values for the coherence parameter, including a fallback precoder CB set corresponding to the other value for the coherence parameter, and a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the fallback precoder CB sets corresponding to the one or more other values for the coherence parameter.

In a ninth aspect, alone or in combination with one or more of the first through eighth aspects, the second capability information includes an indication of the one or more other values, greater than the minimum supported value, for the coherence parameter, and the one or more supported combinations of one or more precoder CB sets include respective supported combinations for a subset of a set of possible combinations of one or more of precoder CB sets corresponding to one or more of the minimum supported value for the coherence parameter or the one or more other values, greater than the minimum supported value, for the coherence parameter.

In a tenth aspect, alone or in combination with one or more of the first through ninth aspects, the one or more other values include a single indicated value, greater than the minimum supported value, for the coherence parameter, and the one or more supported combinations of one or more precoder CB sets include a supported combination that includes the precoder CB set corresponding to the minimum supported value for the coherence parameter and a fallback precoder CB set corresponding to the single indicated value, greater than the minimum supported value, for the coherence parameter, and a supported combination that includes the fallback precoder CB set corresponding to the single indicated value, greater than the minimum supported value, for the coherence parameter and does not include the precoder CB corresponding to the minimum supported value for the coherence parameter.

In an eleventh aspect, alone or in combination with one or more of the first through tenth aspects, the one or more other values include multiple indicated values, greater than the minimum supported value, for the coherence parameter, and the one or more supported combinations of one or more precoder CB sets include a supported combination that includes the precoder CB set corresponding to the minimum supported value for the coherence parameter and a respective fallback precoder CB set corresponding to each indicated value of the multiple indicated values, greater than the minimum supported value, for the coherence parameter, a supported respective combination, for each combination of two or more values of the multiple indicated values, greater than the minimum supported value, for the coherence parameter, that includes a respective combination of fallback precoder CB sets corresponding to the combination of the two or more values of the multiple indicated values, and a supported combination that includes a single fallback precoder CB set corresponding to a highest value of the multiple indicated values, greater than the minimum supported value, for the coherence parameter.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with 8Tx UE precoder CB fallback.

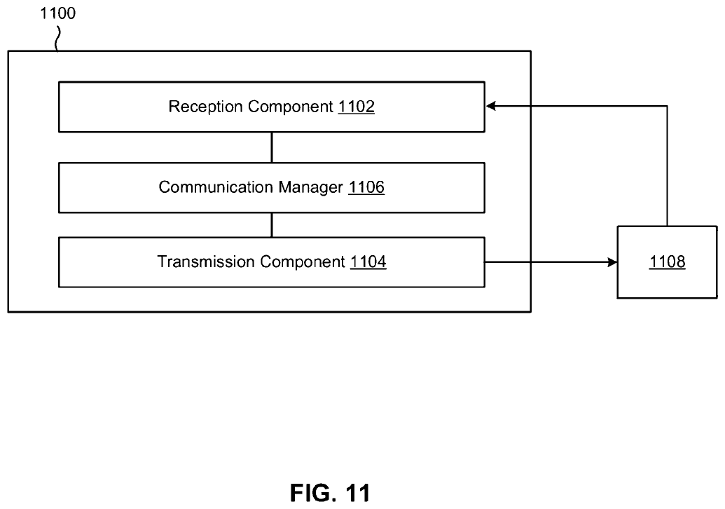

As shown in FIG. 7, in some aspects, process 700 may include receiving, from a UE, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter (block 710). For example, the network node (e.g., using reception component 1102 and/or communication manager 1106, depicted in FIG. 11) may receive, from a UE, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter, as described above.

As further shown in FIG. 7, in some aspects, process 700 may include transmitting, to the UE, configuration information indicating a configured combination of one or more precoder CB sets, wherein the configured combination of one or more precoder CB sets is selected from the one or more supported combinations of one or more precoder CB sets (block 720). For example, the network node (e.g., using transmission component 1104 and/or communication manager 1106, depicted in FIG. 11) may transmit, to the UE, configuration information indicating a configured combination of one or more precoder CB sets, wherein the configured combination of one or more precoder CB sets is selected from the one or more supported combinations of one or more precoder CB sets, as described above.

Process 700 may include additional aspects, such as any single aspect or any combination of aspects described below and/or in connection with one or more other processes described elsewhere herein.

In a first aspect, process 700 includes transmitting, to the UE, an uplink grant for an uplink communication, the uplink grant indicating a precoder CB from a precoder CB set of the configured combination of one or more precoder CB sets indicated in the configuration information, and receiving, from the UE, the uplink communication based at least in part on a precoding matrix associated with the precoder CB indicated in the uplink grant.

In a second aspect, alone or in combination with the first aspect, the quantity of Tx antennas is eight Tx antennas, and the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.

In a third aspect, alone or in combination with one or more of the first and second aspects, the second capability information includes, for each of the one or more supported combinations of one or more precoder CB sets, a respective indication of one or more values for the coherence parameter that correspond to the one or more precoder CB sets included in that supported combination of one or more precoder CB sets.

In a fourth aspect, alone or in combination with one or more of the first through third aspects, the one or more supported combinations of one or more precoder CB sets include a supported combination that includes the precoder CB set corresponding to the minimum supported value for the coherence parameter and the one or more fallback precoder CB sets corresponding to the one or more other values, greater than the minimum supported value, for the coherence parameter.

In a fifth aspect, alone or in combination with one or more of the first through fourth aspects, the one or more supported combinations of one or more precoder CB sets include a supported combination that includes at least one of the one or more fallback precoder CB sets corresponding to the one or more other values, greater than the minimum supported value, for the coherence parameter, and does not include the precoder CB set corresponding to the minimum supported value for the coherence parameter.

In a sixth aspect, alone or in combination with one or more of the first through fifth aspects, the one or more supported combinations of one or more precoder CB sets include a supported combination that includes at least two fallback precoder CB sets corresponding to at least two other values, greater than the minimum supported value, for the coherence parameter.

In a seventh aspect, alone or in combination with one or more of the first through sixth aspects, the second capability information includes an indication of the one or more other values, greater than the minimum supported value, for the coherence parameter, and the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.

In an eighth aspect, alone or in combination with one or more of the first through seventh aspects, the second capability information includes an indication of the one or more other values, greater than the minimum supported value, for the coherence parameter, and the one or more supported combinations of one or more precoder CB sets include a supported combination including the precoder CB set corresponding to the minimum supported value for the coherence parameter, a respective supported combination, for each other value of the one or more other values for the coherence parameter, including a fallback precoder CB set corresponding to the other value for the coherence parameter, and a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the fallback precoder CB sets corresponding to the one or more other values for the coherence parameter.

In a ninth aspect, alone or in combination with one or more of the first through eighth aspects, the second capability information includes an indication of the one or more other values, greater than the minimum supported value, for the coherence parameter, and the one or more supported combinations of one or more precoder CB sets include respective supported combinations for a subset of a set of possible combinations of one or more of precoder CB sets corresponding to one or more of the minimum supported value for the coherence parameter or the one or more other values, greater than the minimum supported value, for the coherence parameter.

In a tenth aspect, alone or in combination with one or more of the first through ninth aspects, the one or more other values include a single indicated value, greater than the minimum supported value, for the coherence parameter, and the one or more supported combinations of one or more precoder CB sets include a supported combination that includes the precoder CB set corresponding to the minimum supported value for the coherence parameter and a fallback precoder CB set corresponding to the single indicated value, greater than the minimum supported value, for the coherence parameter, and a supported combination that includes the fallback precoder CB set corresponding to the single indicated value, greater than the minimum supported value, for the coherence parameter and does not include the precoder CB corresponding to the minimum supported value for the coherence parameter.

In an eleventh aspect, alone or in combination with one or more of the first through tenth aspects, the one or more other values include multiple indicated values, greater than the minimum supported value, for the coherence parameter, and the one or more supported combinations of one or more precoder CB sets include a supported combination that includes the precoder CB set corresponding to the minimum supported value for the coherence parameter and a respective fallback precoder CB set corresponding to each indicated value of the multiple indicated values, greater than the minimum supported value, for the coherence parameter, a respective supported combination, for each combination of two or more values of the multiple indicated values, greater than the minimum supported value, for the coherence parameter, that includes a respective combination of fallback precoder CB sets corresponding to the combination of the two or more values of the multiple indicated values, and a supported combination that includes a single fallback precoder CB set corresponding to a highest value of the multiple indicated values, greater than the minimum supported value, for the coherence parameter.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with 8Tx UE precoder CB fallback.

As shown in FIG. 8, in some aspects, process 800 may include transmitting, to a network node, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas (block 810). For example, the UE (e.g., using transmission component 1004 and/or communication manager 1006, depicted in FIG. 10) may transmit, to a network node, capability information including: first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas, as described above.

As further shown in FIG. 8, in some aspects, process 800 may include receiving, from the network node, configuration information indicating a combination of one or more precoder CB sets, wherein the combination of one or more precoder CB sets is from one or more supported combinations of one or more precoder CB sets based at least in part on the first capability information and the second capability information (block 820). For example, the UE (e.g., using reception component 1002 and/or communication manager 1006, depicted in FIG. 10) may receive, from the network node, configuration information indicating a combination of one or more precoder CB sets, wherein the combination of one or more precoder CB sets is from one or more supported combinations of one or more precoder CB sets based at least in part on the first capability information and the second capability information, as described above.

Process 800 may include additional aspects, such as any single aspect or any combination of aspects described below and/or in connection with one or more other processes described elsewhere herein.

In a first aspect, each of the one or more supported combinations includes one or more precoder CB sets including at least one of a precoder CB set corresponding to the minimum supported value for the coherence parameter or one or more fallback precoder CB sets of the one or more supported fallback precoder CB sets.

In a second aspect, alone or in combination with the first aspect, process 800 includes receiving, from the network node, an uplink grant for an uplink communication, the uplink grant indicating a precoder CB from a precoder CB set of the combination of one or more precoder CB sets indicated in the configuration information, and transmitting, to the network node, the uplink communication based at least in part on a precoding matrix associated with the precoder CB indicated in the uplink grant.

In a third aspect, alone or in combination with one or more of the first and second aspects, the quantity of Tx antennas is eight Tx antennas, and the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.

In a fourth aspect, alone or in combination with one or more of the first through third aspects, the one or more supported combinations of one or more precoder CB sets include respective supported combinations for all combinations of one or more of precoder CB sets corresponding to one or more of: the minimum supported value for the coherence parameter, or the one or more other values, greater than the minimum supported value, for the coherence parameter.

In a fifth aspect, alone or in combination with one or more of the first through fourth aspects, the one or more supported combinations of one or more precoder CB sets include a supported combination including a precoder CB set corresponding to the minimum supported value for the coherence parameter, a respective supported combination, for each other value of the one or more other values for the coherence parameter, including a fallback precoder CB set, of the one or more supported fallback precoder CB sets, corresponding to the other value for the coherence parameter, and a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the one or more supported fallback precoder CB sets corresponding to the one or more other values for the coherence parameter.

In a sixth aspect, alone or in combination with one or more of the first through fifth aspects, the one or more supported combinations of one or more precoder CB sets include respective supported combinations for a subset of a set of possible combinations of one or more of precoder CB sets corresponding to one or more of the minimum supported value for the coherence parameter or the one or more other values, greater than the minimum supported value, for the coherence parameter.

In a seventh aspect, alone or in combination with one or more of the first through sixth aspects, the one or more other values include a single indicated value, greater than the minimum supported value, for the coherence parameter, and the one or more supported combinations of one or more precoder CB sets include a supported combination that includes a precoder CB set corresponding to the minimum supported value for the coherence parameter and a fallback precoder CB set corresponding to the single indicated value, greater than the minimum supported value, for the coherence parameter, and a supported combination that includes the fallback precoder CB set corresponding to the single indicated value, greater than the minimum supported value, for the coherence parameter, and does not include the precoder CB corresponding to the minimum supported value for the coherence parameter.

In an eighth aspect, alone or in combination with one or more of the first through seventh aspects, the one or more other values include multiple indicated values, greater than the minimum supported value, for the coherence parameter, and the one or more supported combinations of one or more precoder CB sets include a supported combination that includes a precoder CB set corresponding to the minimum supported value for the coherence parameter and a respective fallback precoder CB set corresponding to each indicated value of the multiple indicated values, greater than the minimum supported value, for the coherence parameter, a respective supported combination, for each combination of two or more values of the multiple indicated values, greater than the minimum supported value, for the coherence parameter, that includes a respective combination of fallback precoder CB sets corresponding to the combination of the two or more values of the multiple indicated values, and a supported combination that includes a single fallback precoder CB set corresponding to a highest value of the multiple indicated values, greater than the minimum supported value, for the coherence parameter.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with 8Tx CB precoder CB fallback.

As shown in FIG. 9, in some aspects, process 900 may include receiving, from a CB, capability information including: first capability information that indicates a minimum supported value, of a plurality of values, for a coherence parameter associated with a coherence level for a quantity of Tx antennas of the CB, wherein each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas (block 910). For example, the network node (e.g., using reception component 1102 and/or communication manager 1106, depicted in FIG. 11) may receive, from a user CB, capability information including: first capability information that indicates a minimum supported value, of a plurality of values, for a coherence parameter associated with a coherence level for a quantity of Tx antennas of the CB, wherein each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas, as described above.

As further shown in FIG. 9, in some aspects, process 900 may include transmitting, to the CB, configuration information indicating a combination of one or more precoder CB sets, wherein the combination of one or more precoder CB sets is selected from one or more supported combinations of one or more precoder CB sets based at least in part on the first capability information and the second capability information (block 920). For example, the network node (e.g., using transmission component 1104 and/or communication manager 1106, depicted in FIG. 11) may transmit, to the CB, configuration information indicating a combination of one or more precoder CB sets, wherein the combination of one or more precoder CB sets is selected from one or more supported combinations of one or more precoder CB sets based at least in part on the first capability information and the second capability information, as described above.

Process 900 may include additional aspects, such as any single aspect or any combination of aspects described below and/or in connection with one or more other processes described elsewhere herein.

In a first aspect, each of the one or more supported combinations includes one or more precoder CB sets including at least one of a precoder CB set corresponding to the minimum supported value for the coherence parameter or one or more fallback precoder CB sets of the one or more supported fallback precoder CB sets.

In a second aspect, alone or in combination with the first aspect, process 900 includes transmitting, to the CB, an uplink grant for an uplink communication, the uplink grant indicating a precoder CB from a precoder CB set of the combination of one or more precoder CB sets indicated in the configuration information, and receiving, from the CB, the uplink communication based at least in part on a precoding matrix associated with the precoder CB indicated in the uplink grant.

In a third aspect, alone or in combination with one or more of the first and second aspects, the quantity of Tx antennas is eight Tx antennas, and the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.

In a fourth aspect, alone or in combination with one or more of the first through third aspects, the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.

In a fifth aspect, alone or in combination with one or more of the first through fourth aspects, the one or more supported combinations of one or more precoder CB sets include a supported combination including a precoder CB set corresponding to the minimum supported value for the coherence parameter, a respective supported combination, for each other value of the one or more other values for the coherence parameter, including a fallback precoder CB set, of the one or more supported fallback precoder CB sets, corresponding to the other value for the coherence parameter, and a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the one or more supported fallback precoder CB sets corresponding to the one or more other values for the coherence parameter.

In a sixth aspect, alone or in combination with one or more of the first through fifth aspects, the one or more supported combinations of one or more precoder CB sets include respective supported combinations for a subset of a set of possible combinations of one or more of: precoder CB sets corresponding to one or more of the minimum supported value for the coherence parameter, or the one or more other values, greater than the minimum supported value, for the coherence parameter.

In a seventh aspect, alone or in combination with one or more of the first through sixth aspects, the one or more other values include a single indicated value, greater than the minimum supported value, for the coherence parameter, and the one or more supported combinations of one or more precoder CB sets include a supported combination that includes a precoder CB set corresponding to the minimum supported value for the coherence parameter and a fallback precoder CB set corresponding to the single indicated value, greater than the minimum supported value, for the coherence parameter, and a supported combination that includes the fallback precoder CB set corresponding to the single indicated value, greater than the minimum supported value, for the coherence parameter, and does not include the precoder CB corresponding to the minimum supported value for the coherence parameter.

In an eighth aspect, alone or in combination with one or more of the first through seventh aspects, the one or more other values include multiple indicated values, greater than the minimum supported value, for the coherence parameter, and the one or more supported combinations of one or more precoder CB sets include a supported combination that includes a precoder CB set corresponding to the minimum supported value for the coherence parameter and a respective fallback precoder CB set corresponding to each indicated value of the multiple indicated values, greater than the minimum supported value, for the coherence parameter, a respective supported combination, for each combination of two or more values of the multiple indicated values, greater than the minimum supported value, for the coherence parameter, that includes a respective combination of fallback precoder CB sets corresponding to the combination of the two or more values of the multiple indicated values, and a supported combination that includes a single fallback precoder CB set corresponding to a highest value of the multiple indicated values, greater than the minimum supported value, for the coherence parameter.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4-5. Additionally, or alternatively, the apparatus 1000 may be configured to perform one or more processes described herein, such as process 600 of FIG. 6 and/or process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

In some aspects, the transmission component 1004 may transmit, to a network node, capability information including first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter. The reception component 1002 may receive, from the network node, configuration information indicating a configured combination of one or more precoder CB sets, wherein the configured combination of one or more precoder CB sets is selected from the one or more supported combinations of one or more precoder CB sets.

In some aspects, the transmission component 1004 may transmit, to a network node, capability information including first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas. The reception component 1002 may receive, from the network node, configuration information indicating a combination of one or more precoder CB sets, wherein the combination of one or more precoder CB sets is from one or more supported combinations of one or more precoder CB sets based at least in part on the first capability information and the second capability information.

The reception component 1002 may receive, from the network node, an uplink grant for an uplink communication, the uplink grant indicating a precoder CB from a precoder CB set of the combination of one or more precoder CB sets indicated in the configuration information.

The transmission component 1004 may transmit, to the network node, the uplink communication based at least in part on a precoding matrix associated with the precoder CB indicated in the uplink grant.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-5 Additionally, or alternatively, the apparatus 1100 may be configured to perform one or more processes described herein, such as process 700 of FIG. 7 and/or process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

In some aspects, the reception component 1102 may receive, from a UE, capability information including first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter. The transmission component 1104 may transmit, to the UE, configuration information indicating a configured combination of one or more precoder CB sets, wherein the configured combination of one or more precoder CB sets is selected from the one or more supported combinations of one or more precoder CB sets.

In some aspects, the reception component 1102 may receive, from a UE, capability information including first capability information that indicates a minimum supported value, of a plurality of values, for a coherence parameter associated with a coherence level for a quantity of Tx antennas of the UE, wherein each value, of the plurality of values, corresponds to a respective precoder CB set, and second capability information that indicates one or more other values of the plurality of values, greater than the minimum supported value, for the coherence parameter that correspond to one or more supported fallback precoder CB sets for the quantity of Tx antennas. The transmission component 1104 may transmit, to the UE, configuration information indicating a combination of one or more precoder CB sets, wherein the combination of one or more precoder CB sets is selected from one or more supported combinations of one or more precoder CB sets based at least in part on the first capability information and the second capability information.

The transmission component 1104 may transmit, to the UE, an uplink grant for an uplink communication, the uplink grant indicating a precoder CB from a precoder CB set of the combination of one or more precoder CB sets indicated in the configuration information.

The reception component 1102 may receive, from the UE, the uplink communication based at least in part on a precoding matrix associated with the precoder CB indicated in the uplink grant.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: transmitting, to a network node, capability information including: first capability information that indicates a minimum supported value, of a plurality of values, for a coherence parameter associated with a coherence level for a quantity of transmit (Tx) antennas of the UE, wherein each value, of the plurality of values, corresponds to a respective precoder codebook (CB) set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter; and receiving, from the network node, configuration information indicating a configured combination of one or more precoder CB sets, wherein the configured combination of one or more precoder CB sets is selected from the one or more supported combinations of one or more precoder CB sets.
Aspect 2: The method of Aspect 1, further comprising: receiving, from the network node, an uplink grant for an uplink communication, the uplink grant indicating a precoder CB from a precoder CB set of the configured combination of one or more precoder CB sets indicated in the configuration information; and transmitting, to the network node, the uplink communication based at least in part on a precoding matrix associated with the precoder CB indicated in the uplink grant.
Aspect 3: The method of any of Aspects 1-2, wherein the quantity of Tx antennas is eight Tx antennas, and wherein the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.
Aspect 4: The method of any of Aspects 1-3, wherein the second capability information includes, for each of the one or more supported combinations of one or more precoder CB sets, a respective indication of one or more values for the coherence parameter that correspond to the one or more precoder CB sets included in that supported combination of one or more precoder CB sets.
Aspect 5: The method of Aspect 4, wherein the one or more supported combinations of one or more precoder CB sets include a supported combination that includes the precoder CB set corresponding to the minimum supported value for the coherence parameter and the one or more fallback precoder CB sets corresponding to the one or more other values, greater than the minimum supported value, for the coherence parameter.
Aspect 6: The method of Aspect 4, wherein the one or more supported combinations of one or more precoder CB sets include a supported combination that includes at least one of the one or more fallback precoder CB sets corresponding to the one or more other values, greater than the minimum supported value, for the coherence parameter, and does not include the precoder CB set corresponding to the minimum supported value for the coherence parameter.
Aspect 7: The method of any of Aspects 4-6, wherein the one or more supported combinations of one or more precoder CB sets include a supported combination that includes at least two fallback precoder CB sets corresponding to at least two other values, greater than the minimum supported value, for the coherence parameter.
Aspect 8: The method of any of Aspects 1-3, wherein the second capability information includes an indication of the one or more other values, greater than the minimum supported value, for the coherence parameter, and wherein the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.
Aspect 9: The method of any of Aspects 1-3 and 8, wherein the second capability information includes an indication of the one or more other values, greater than the minimum supported value, for the coherence parameter, and wherein the one or more supported combinations of one or more precoder CB sets include: a supported combination including the precoder CB set corresponding to the minimum supported value for the coherence parameter, a respective supported combination, for each other value of the one or more other values for the coherence parameter, including a fallback precoder CB set corresponding to the other value for the coherence parameter, and a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the fallback precoder CB sets corresponding to the one or more other values for the coherence parameter.
Aspect 10: The method of any of Aspects 1-3, wherein the second capability information includes an indication of the one or more other values, greater than the minimum supported value, for the coherence parameter, and wherein the one or more supported combinations of one or more precoder CB sets include respective supported combinations for a subset of a set of possible combinations of one or more of precoder CB sets corresponding to one or more of the minimum supported value for the coherence parameter or the one or more other values, greater than the minimum supported value, for the coherence parameter.
Aspect 11: The method of Aspect 10, wherein the one or more other values include a single indicated value, greater than the minimum supported value, for the coherence parameter, and wherein the one or more supported combinations of one or more precoder CB sets include: a supported combination that includes the precoder CB set corresponding to the minimum supported value for the coherence parameter and a fallback precoder CB set corresponding to the single indicated value, greater than the minimum supported value, for the coherence parameter, and a supported combination that includes the fallback precoder CB set corresponding to the single indicated value, greater than the minimum supported value, for the coherence parameter and does not include the precoder CB corresponding to the minimum supported value for the coherence parameter.
Aspect 12: The method of Aspect 10, wherein the one or more other values include multiple indicated values, greater than the minimum supported value, for the coherence parameter, and wherein the one or more supported combinations of one or more precoder CB sets include: a supported combination that includes the precoder CB set corresponding to the minimum supported value for the coherence parameter and a respective fallback precoder CB set corresponding to each indicated value of the multiple indicated values, greater than the minimum supported value, for the coherence parameter, a respective supported combination, for each combination of two or more values of the multiple indicated values, greater than the minimum supported value, for the coherence parameter, that includes a respective combination of fallback precoder CB sets corresponding to the combination of the two or more values of the multiple indicated values, and a supported combination that includes a single fallback precoder CB set corresponding to a highest value of the multiple indicated values, greater than the minimum supported value, for the coherence parameter.
Aspect 13: A method of wireless communication performed by a network node, comprising: receiving, from a user equipment (UE), capability information including: first capability information that indicates a minimum supported value, of a plurality of values, for a coherence parameter associated with a coherence level for a quantity of transmit (Tx) antennas of the UE, wherein each value, of the plurality of values, corresponds to a respective precoder codebook (CB) set, and second capability information that indicates one or more supported combinations of one or more precoder CB sets, each of the one or more supported combinations including one or more precoder CB sets including at least one of a precoder CB set corresponding to the minimum supported value for the coherence parameter or one or more fallback precoder CB sets corresponding to one or more other values, greater than the minimum supported value, for the coherence parameter; and transmitting, to the UE, configuration information indicating a configured combination of one or more precoder CB sets, wherein the configured combination of one or more precoder CB sets is selected from the one or more supported combinations of one or more precoder CB sets.
Aspect 14: The method of Aspect 13, further comprising: transmitting, to the UE, an uplink grant for an uplink communication, the uplink grant indicating a precoder CB from a precoder CB set of the configured combination of one or more precoder CB sets indicated in the configuration information; and receiving, from the UE, the uplink communication based at least in part on a precoding matrix associated with the precoder CB indicated in the uplink grant.
Aspect 15: The method of any of Aspects 13-14, wherein the quantity of Tx antennas is eight Tx antennas, and wherein the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.
Aspect 16: The method of any of Aspects 13-15, wherein the second capability information includes, for each of the one or more supported combinations of one or more precoder CB sets, a respective indication of one or more values for the coherence parameter that correspond to the one or more precoder CB sets included in that supported combination of one or more precoder CB sets.
Aspect 17: The method of Aspect 16, wherein the one or more supported combinations of one or more precoder CB sets include a supported combination that includes the precoder CB set corresponding to the minimum supported value for the coherence parameter and the one or more fallback precoder CB sets corresponding to the one or more other values, greater than the minimum supported value, for the coherence parameter.
Aspect 18: The method of Aspect 16, wherein the one or more supported combinations of one or more precoder CB sets include a supported combination that includes at least one of the one or more fallback precoder CB sets corresponding to the one or more other values, greater than the minimum supported value, for the coherence parameter, and does not include the precoder CB set corresponding to the minimum supported value for the coherence parameter.
Aspect 19: The method of any of Aspects 16-18, wherein the one or more supported combinations of one or more precoder CB sets include a supported combination that includes at least two fallback precoder CB sets corresponding to at least two other values, greater than the minimum supported value, for the coherence parameter.
Aspect 20: The method of any of Aspects 13-15, wherein the second capability information includes an indication of the one or more other values, greater than the minimum supported value, for the coherence parameter, and wherein the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.
Aspect 21: The method of any of Aspects 13-15 and 20, wherein the second capability information includes an indication of the one or more other values, greater than the minimum supported value, for the coherence parameter, and wherein the one or more supported combinations of one or more precoder CB sets include: a supported combination including the precoder CB set corresponding to the minimum supported value for the coherence parameter, a respective supported combination, for each other value of the one or more other values for the coherence parameter, including a fallback precoder CB set corresponding to the other value for the coherence parameter, and a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the fallback precoder CB sets corresponding to the one or more other values for the coherence parameter.
Aspect 22: The method of any of Aspects 13-15, wherein the second capability information includes an indication of the one or more other values, greater than the minimum supported value, for the coherence parameter, and wherein the one or more supported combinations of one or more precoder CB sets include respective supported combinations for a subset of a set of possible combinations of one or more of precoder CB sets corresponding to one or more of the minimum supported value for the coherence parameter or the one or more other values, greater than the minimum supported value, for the coherence parameter.
Aspect 23: The method of Aspect 22, wherein the one or more other values include a single indicated value, greater than the minimum supported value, for the coherence parameter, and wherein the one or more supported combinations of one or more precoder CB sets include: a supported combination that includes the precoder CB set corresponding to the minimum supported value for the coherence parameter and a fallback precoder CB set corresponding to the single indicated value, greater than the minimum supported value, for the coherence parameter, and a supported combination that includes the fallback precoder CB set corresponding to the single indicated value, greater than the minimum supported value, for the coherence parameter and does not include the precoder CB corresponding to the minimum supported value for the coherence parameter.
Aspect 24: The method of Aspect 22, wherein the one or more other values include multiple indicated values, greater than the minimum supported value, for the coherence parameter, and wherein the one or more supported combinations of one or more precoder CB sets include: a supported combination that includes the precoder CB set corresponding to the minimum supported value for the coherence parameter and a respective fallback precoder CB set corresponding to each indicated value of the multiple indicated values, greater than the minimum supported value, for the coherence parameter, a respective supported combination, for each combination of two or more values of the multiple indicated values, greater than the minimum supported value, for the coherence parameter, that includes a respective combination of fallback precoder CB sets corresponding to the combination of the two or more values of the multiple indicated values, and a supported combination that includes a single fallback precoder CB set corresponding to a highest value of the multiple indicated values, greater than the minimum supported value, for the coherence parameter.
Aspect 25: A method of wireless communication performed by a user equipment (UE), comprising: transmitting, to a network node, capability information including: first capability information that indicates a minimum supported value, of a plurality of values, for a coherence parameter associated with a coherence level for a quantity of transmit (Tx) antennas of the UE, wherein each value, of the plurality of values, corresponds to a respective precoder codebook (CB) set, and second capability information that indicates one or more other values of the plurality of values, greater than the minimum supported value, for the coherence parameter that correspond to one or more supported fallback precoder CB sets for the quantity of Tx antennas; and receiving, from the network node, configuration information indicating a combination of one or more precoder CB sets, wherein the combination of one or more precoder CB sets is from one or more supported combinations of one or more precoder CB sets based at least in part on the first capability information and the second capability information.
Aspect 26: The method of Aspect 25, wherein each of the one or more supported combinations includes one or more precoder CB sets including at least one of a precoder CB set corresponding to the minimum supported value for the coherence parameter or one or more fallback precoder CB sets of the one or more supported fallback precoder CB sets.
Aspect 27: The method of any of Aspects 25-26, further comprising: receiving, from the network node, an uplink grant for an uplink communication, the uplink grant indicating a precoder CB from a precoder CB set of the combination of one or more precoder CB sets indicated in the configuration information; and transmitting, to the network node, the uplink communication based at least in part on a precoding matrix associated with the precoder CB indicated in the uplink grant.
Aspect 28: The method of any of Aspects 25-27, wherein the quantity of Tx antennas is eight Tx antennas, and wherein the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.
Aspect 29: The method of any of Aspects 25-28, wherein the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.
Aspect 30: The method of any of Aspects 25-29, wherein the one or more supported combinations of one or more precoder CB sets include: a supported combination including a precoder CB set corresponding to the minimum supported value for the coherence parameter, a respective supported combination, for each other value of the one or more other values for the coherence parameter, including a fallback precoder CB set, of the one or more supported fallback precoder CB sets, corresponding to the other value for the coherence parameter, and a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the one or more supported fallback precoder CB sets corresponding to the one or more other values for the coherence parameter.
Aspect 31: The method of any of Aspects 25-28, wherein the one or more supported combinations of one or more precoder CB sets include respective supported combinations for a subset of a set of possible combinations of one or more of precoder CB sets corresponding to one or more of the minimum supported value for the coherence parameter or the one or more other values, greater than the minimum supported value, for the coherence parameter.
Aspect 32: The method of Aspect 31, wherein the one or more other values include a single indicated value, greater than the minimum supported value, for the coherence parameter, and wherein the one or more supported combinations of one or more precoder CB sets include: a supported combination that includes a precoder CB set corresponding to the minimum supported value for the coherence parameter and a fallback precoder CB set corresponding to the single indicated value, greater than the minimum supported value, for the coherence parameter, and a supported combination that includes the fallback precoder CB set corresponding to the single indicated value, greater than the minimum supported value, for the coherence parameter and does not include the precoder CB corresponding to the minimum supported value for the coherence parameter.
Aspect 33: The method of Aspect 31, wherein the one or more other values include multiple indicated values, greater than the minimum supported value, for the coherence parameter, and wherein the one or more supported combinations of one or more precoder CB sets include: a supported combination that includes a precoder CB set corresponding to the minimum supported value for the coherence parameter and a respective fallback precoder CB set corresponding to each indicated value of the multiple indicated values, greater than the minimum supported value, for the coherence parameter, a respective supported combination, for each combination of two or more values of the multiple indicated values, greater than the minimum supported value, for the coherence parameter, that includes a respective combination of fallback precoder CB sets corresponding to the combination of the two or more values of the multiple indicated values, and a supported combination that includes a single fallback precoder CB set corresponding to a highest value of the multiple indicated values, greater than the minimum supported value, for the coherence parameter.
Aspect 34: A method of wireless communication performed by a network node, comprising: receiving, from a user equipment (UE), capability information including: first capability information that indicates a minimum supported value, of a plurality of values, for a coherence parameter associated with a coherence level for a quantity of transmit (Tx) antennas of the UE, wherein each value, of the plurality of values, corresponds to a respective precoder codebook (CB) set, and second capability information that indicates one or more other values of the plurality of values, greater than the minimum supported value, for the coherence parameter that correspond to one or more supported fallback precoder CB sets for the quantity of Tx antennas; and transmitting, to the UE, configuration information indicating a combination of one or more precoder CB sets, wherein the combination of one or more precoder CB sets is selected from one or more supported combinations of one or more precoder CB sets based at least in part on the first capability information and the second capability information.
Aspect 35: The method of Aspect 34, wherein each of the one or more supported combinations includes one or more precoder CB sets including at least one of a precoder CB set corresponding to the minimum supported value for the coherence parameter or one or more fallback precoder CB sets of the one or more supported fallback precoder CB sets.
Aspect 36: The method of any of Aspects 34-35, further comprising: transmitting, to the UE, an uplink grant for an uplink communication, the uplink grant indicating a precoder CB from a precoder CB set of the combination of one or more precoder CB sets indicated in the configuration information; and receiving, from the UE, the uplink communication based at least in part on a precoding matrix associated with the precoder CB indicated in the uplink grant.

Aspect 37: The method of any of Aspects 34-36, wherein the quantity of Tx antennas is eight Tx antennas, and wherein the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.

Aspect 38: The method of any of Aspects 34-37, wherein the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.

Aspect 39: The method of any of Aspects 34-38, wherein the one or more supported combinations of one or more precoder CB sets include: a supported combination including a precoder CB set corresponding to the minimum supported value for the coherence parameter, a respective supported combination, for each other value of the one or more other values for the coherence parameter, including a fallback precoder CB set, of the one or more supported fallback precoder CB sets, corresponding to the other value for the coherence parameter, and a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the one or more supported fallback precoder CB sets corresponding to the one or more other values for the coherence parameter.

Aspect 40: The method of any of Aspects 34-37, wherein the one or more supported combinations of one or more precoder CB sets include respective supported combinations for a subset of a set of possible combinations of one or more of precoder CB sets corresponding to one or more of the minimum supported value for the coherence parameter or the one or more other values, greater than the minimum supported value, for the coherence parameter.

Aspect 41: The method of Aspect 40, wherein the one or more other values include a single indicated value, greater than the minimum supported value, for the coherence parameter, and wherein the one or more supported combinations of one or more precoder CB sets include: a supported combination that includes a precoder CB set corresponding to the minimum supported value for the coherence parameter and a fallback precoder CB set corresponding to the single indicated value, greater than the minimum supported value, for the coherence parameter, and a supported combination that includes the fallback precoder CB set corresponding to the single indicated value, greater than the minimum supported value, for the coherence parameter and does not include the precoder CB corresponding to the minimum supported value for the coherence parameter.

Aspect 42: The method of Aspect 40, wherein the one or more other values include multiple indicated values, greater than the minimum supported value, for the coherence parameter, and wherein the one or more supported combinations of one or more precoder CB sets include: a supported combination that includes a precoder CB set corresponding to the minimum supported value for the coherence parameter and a respective fallback precoder CB set corresponding to each indicated value of the multiple indicated values, greater than the minimum supported value, for the coherence parameter, a respective supported combination, for each combination of two or more values of the multiple indicated values, greater than the minimum supported value, for the coherence parameter, that includes a respective combination of fallback precoder CB sets corresponding to the combination of the two or more values of the multiple indicated values, and a supported combination that includes a single fallback precoder CB set corresponding to a highest value of the multiple indicated values, greater than the minimum supported value, for the coherence parameter.

Aspect 43: An apparatus for wireless communication at a device, comprising a processor; memory coupled with the processor; and instructions stored in the memory and executable by the processor to cause the apparatus to perform the method of one or more of Aspects 1-42.

Aspect 44: A device for wireless communication, comprising a memory and one or more processors coupled to the memory, the one or more processors configured to perform the method of one or more of Aspects 1-42.

Aspect 45: An apparatus for wireless communication, comprising at least one means for performing the method of one or more of Aspects 1-42.

Aspect 46: A non-transitory computer-readable medium storing code for wireless communication, the code comprising instructions executable by a processor to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
transmit, to a network node, capability information including:
first capability information that indicates a minimum supported value, of a plurality of values, for a coherence parameter associated with a coherence level for a quantity of transmit (Tx) antennas of the UE, wherein each value, of the plurality of values, corresponds to a respective precoder codebook (CB) set, and
second capability information that indicates one or more other values of the plurality of values, greater than the minimum supported value, for the coherence parameter that correspond to one or more supported fallback precoder CB sets for the quantity of Tx antennas; and
receive, from the network node, configuration information indicating a combination of one or more precoder CB sets, wherein the combination of one or more precoder CB sets is from one or more supported combinations of one or more precoder CB sets based at least in part on the first capability information and the second capability information.

2. The UE of claim 1, wherein each of the one or more supported combinations includes one or more precoder CB sets including at least one of a precoder CB set corresponding to the minimum supported value for the coherence parameter or one or more fallback precoder CB sets of the one or more supported fallback precoder CB sets.

3. The UE of claim 1, wherein the one or more processors are further configured to:
receive, from the network node, an uplink grant for an uplink communication, the uplink grant indicating a precoder CB from a precoder CB set of the combination of one or more precoder CB sets indicated in the configuration information; and
transmit, to the network node, the uplink communication based at least in part on a precoding matrix associated with the precoder CB indicated in the uplink grant.

4. The UE of claim 1, wherein the quantity of Tx antennas is eight Tx antennas, and wherein the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.

5. The UE of claim 1, wherein the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.

6. The UE of claim 1, wherein the one or more supported combinations of one or more precoder CB sets include:
a supported combination including a precoder CB set corresponding to the minimum supported value for the coherence parameter,
a respective supported combination, for each other value of the one or more other values for the coherence parameter, including a fallback precoder CB set, of the one or more supported fallback precoder CB sets, corresponding to the other value for the coherence parameter, and
a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the one or more supported fallback precoder CB sets corresponding to the one or more other values for the coherence parameter.

7. The UE of claim 1, wherein the one or more supported combinations of one or more precoder CB sets include respective supported combinations for a subset of a set of possible combinations of one or more of precoder CB sets corresponding to one or more of the minimum supported value for the coherence parameter or the one or more other values, greater than the minimum supported value, for the coherence parameter.

8. The UE of claim 7, wherein the one or more other values include a single indicated value, greater than the minimum supported value, for the coherence parameter, and wherein the one or more supported combinations of one or more precoder CB sets include:
a supported combination that includes a precoder CB set corresponding to the minimum supported value for the coherence parameter and a fallback precoder CB set corresponding to the single indicated value, greater than the minimum supported value, for the coherence parameter, and
a supported combination that includes the fallback precoder CB set corresponding to the single indicated value, greater than the minimum supported value, for the coherence parameter and does not include the precoder CB corresponding to the minimum supported value for the coherence parameter.

9. The UE of claim 7, wherein the one or more other values include multiple indicated values, greater than the minimum supported value, for the coherence parameter, and wherein the one or more supported combinations of one or more precoder CB sets include:
a supported combination that includes a precoder CB set corresponding to the minimum supported value for the coherence parameter and a respective fallback precoder CB set corresponding to each indicated value of the multiple indicated values, greater than the minimum supported value, for the coherence parameter,
a respective supported combination, for each combination of two or more values of the multiple indicated values, greater than the minimum supported value, for the coherence parameter, that includes a respective combination of fallback precoder CB sets corresponding to the combination of the two or more values of the multiple indicated values, and
a supported combination that includes a single fallback precoder CB set corresponding to a highest value of the multiple indicated values, greater than the minimum supported value, for the coherence parameter.

10. A network node for wireless communication, comprising:
one or more memories; and
one or more processors, coupled to the one or more memories, configured to:
receive, from a user equipment (UE), capability information including:
first capability information that indicates a minimum supported value, of a plurality of values, for a coherence parameter associated with a coherence level for a quantity of transmit (Tx) antennas of the UE, wherein each value, of the plurality of values, corresponds to a respective precoder codebook (CB) set, and
second capability information that indicates one or more other values of the plurality of values, greater than the minimum supported value, for the coherence parameter that correspond to one or more supported fallback precoder CB sets for the quantity of Tx antennas; and
transmit, to the UE, configuration information indicating a combination of one or more precoder CB sets, wherein the combination of one or more precoder CB sets is from one or more supported combinations of one or more precoder CB sets based at least in part on the first capability information and the second capability information.

11. The network node of claim 10, wherein each of the one or more supported combinations includes one or more precoder CB sets including at least one of a precoder CB set corresponding to the minimum supported value for the coherence parameter or one or more fallback precoder CB sets of the one or more supported fallback precoder CB sets.

12. The network node of claim 10, wherein the one or more processors are further configured to:
transmit, to the UE, an uplink grant for an uplink communication, the uplink grant indicating a precoder CB from a precoder CB set of the combination of one or more precoder CB sets indicated in the configuration information; and
receive, from the UE, the uplink communication based at least in part on a precoding matrix associated with the precoder CB indicated in the uplink grant.

13. The network node of claim 10, wherein the quantity of Tx antennas is eight Tx antennas, and wherein the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.

14. The network node of claim 10, wherein the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.

15. The network node of claim 10, wherein the one or more supported combinations of one or more precoder CB sets include:
a supported combination including a precoder CB set corresponding to the minimum supported value for the coherence parameter,
a respective supported combination, for each other value of the one or more other values for the coherence parameter, including a fallback precoder CB set, of the one or more supported fallback precoder CB sets, corresponding to the other value for the coherence parameter, and
a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the one or more supported fallback precoder CB sets corresponding to the one or more other values for the coherence parameter.

16. The network node of claim 10, wherein the one or more supported combinations of one or more precoder CB sets include respective supported combinations for a subset of a set of possible combinations of one or more of precoder CB sets corresponding to one or more of the minimum supported value for the coherence parameter or the one or more other values, greater than the minimum supported value, for the coherence parameter.

17. The network node of claim 16, wherein the one or more other values include a single indicated value, greater than the minimum supported value, for the coherence parameter, and wherein the one or more supported combinations of one or more precoder CB sets include:
a supported combination that includes a precoder CB set corresponding to the minimum supported value for the coherence parameter and a fallback precoder CB set corresponding to the single indicated value, greater than the minimum supported value, for the coherence parameter, and
a supported combination that includes the fallback precoder CB set corresponding to the single indicated value, greater than the minimum supported value, for the coherence parameter and does not include the precoder CB corresponding to the minimum supported value for the coherence parameter.

18. The network node of claim 16, wherein the one or more other values include multiple indicated values, greater than the minimum supported value, for the coherence parameter, and wherein the one or more supported combinations of one or more precoder CB sets include:
a supported combination that includes a precoder CB set corresponding to the minimum supported value for the coherence parameter and a respective fallback precoder CB set corresponding to each indicated value of the multiple indicated values, greater than the minimum supported value, for the coherence parameter,
a respective supported combination, for each combination of two or more values of the multiple indicated values, greater than the minimum supported value, for the coherence parameter, that includes a respective combination of fallback precoder CB sets corresponding to the combination of the two or more values of the multiple indicated values, and
a supported combination that includes a single fallback precoder CB set corresponding to a highest value of the multiple indicated values, greater than the minimum supported value, for the coherence parameter.

19. A method of wireless communication performed by a user equipment (UE), comprising:
transmitting, to a network node, capability information including:
first capability information that indicates a minimum supported value, of a plurality of values, for a coherence parameter associated with a coherence level for a quantity of transmit (Tx) antennas of the UE, wherein each value, of the plurality of values, corresponds to a respective precoder codebook (CB) set, and
second capability information that indicates one or more other values of the plurality of values, greater than the minimum supported value, for the coherence parameter that correspond to one or more supported fallback precoder CB sets for the quantity of Tx antennas; and
receiving, from the network node, configuration information indicating a combination of one or more precoder CB sets, wherein the combination of one or more precoder CB sets is selected from one or more supported combinations of one or more precoder CB sets based at least in part on the first capability information and the second capability information.

20. The method of claim 19, wherein each of the one or more supported combinations includes one or more precoder CB sets including at least one of a precoder CB set corresponding to the minimum supported value for the coherence parameter or one or more fallback precoder CB sets of the one or more supported fallback precoder CB sets.

21. The method of claim 19, further comprising:
receiving, from the network node, an uplink grant for an uplink communication, the uplink grant indicating a precoder CB from a precoder CB set of the combination of one or more precoder CB sets indicated in the configuration information; and
transmitting, to the network node, the uplink communication based at least in part on a precoding matrix associated with the precoder CB indicated in the uplink grant.

22. The method of claim 19, wherein the quantity of Tx antennas is eight Tx antennas, and wherein the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.

23. The method of claim 19, wherein the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.

24. The method of claim 19, wherein the one or more supported combinations of one or more precoder CB sets include:
a supported combination including a precoder CB set corresponding to the minimum supported value for the coherence parameter,
a respective supported combination, for each other value of the one or more other values for the coherence parameter, including a fallback precoder CB set, of the one or more supported fallback precoder CB sets, corresponding to the other value for the coherence parameter, and
a respective supported combination, for each combination of two or more values of the coherence parameter among the minimum supported value for the coherence parameter and the one or more other values for the coherence parameter, that includes a respective combination of two or more precoder CB sets among the precoder CB set corresponding to the minimum supported value for the coherence parameter and the one or more supported fallback precoder CB sets corresponding to the one or more other values for the coherence parameter.

25. The method of claim 19, wherein the one or more supported combinations of one or more precoder CB sets include respective supported combinations for a subset of a set of possible combinations of one or more of precoder CB sets corresponding to one or more of the minimum supported value for the coherence parameter or the one or more other values, greater than the minimum supported value, for the coherence parameter.

26. The method of claim 25, wherein the one or more other values include a single indicated value, greater than the minimum supported value, for the coherence parameter, and wherein the one or more supported combinations of one or more precoder CB sets include:
a supported combination that includes a precoder CB set corresponding to the minimum supported value for the coherence parameter and a fallback precoder CB set corresponding to the single indicated value, greater than the minimum supported value, for the coherence parameter, and
a supported combination that includes the fallback precoder CB set corresponding to the single indicated value, greater than the minimum supported value, for the coherence parameter and does not include the precoder CB corresponding to the minimum supported value for the coherence parameter.

27. The method of claim 25, wherein the one or more other values include multiple indicated values, greater than the minimum supported value, for the coherence parameter, and wherein the one or more supported combinations of one or more precoder CB sets include:
a supported combination that includes a precoder CB set corresponding to the minimum supported value for the coherence parameter and a respective fallback precoder CB set corresponding to each indicated value of the multiple indicated values, greater than the minimum supported value, for the coherence parameter,
a respective supported combination, for each combination of two or more values of the multiple indicated values, greater than the minimum supported value, for the coherence parameter, that includes a respective combination of fallback precoder CB sets corresponding to the combination of the two or more values of the multiple indicated values, and
a supported combination that includes a single fallback precoder CB set corresponding to a highest value of the multiple indicated values, greater than the minimum supported value, for the coherence parameter.

28. A method of wireless communication performed by a network node, comprising:
receiving, from a user equipment (UE), capability information including:
first capability information that indicates a minimum supported value, of a plurality of values, for a coherence parameter associated with a coherence level for a quantity of transmit (Tx) antennas of the UE, wherein each value, of the plurality of values, corresponds to a respective precoder codebook (CB) set, and
second capability information that indicates one or more other values of the plurality of values, greater than the minimum supported value, for the coherence parameter that correspond to one or more supported fallback precoder CB sets for the quantity of Tx antennas; and
transmitting, to the UE, configuration information indicating a combination of one or more precoder CB sets, wherein the combination of one or more precoder CB sets is selected from one or more supported combinations of one or more precoder CB sets based at least in part on the first capability information and the second capability information.

29. The method of claim 28, wherein the quantity of Tx antennas is eight Tx antennas, and wherein the plurality of values for the coherence parameter includes a first value associated with full coherence for the eight Tx antennas, a second value associated with partial coherence with two antenna groups for the eight Tx antennas, a third value associated with partial coherence with four antenna groups for the eight Tx antennas, and a fourth value associated with non-coherence for the eight Tx antennas.

30. The method of claim 28, wherein the one or more supported combinations of one or more precoder CB sets include respective supported combinations for all combinations of one or more of precoder CB sets corresponding to one or more of the minimum supported value for the coherence parameter or the one or more other values, greater than the minimum supported value, for the coherence parameter.
